(19) United States
(12) Patent Application Publication
(10) Pub. No.: US 2025/0096269 A1
(43) Pub. Date: Mar. 20, 2025

(54) ELECTRODE COMPOSITION AND BATTERY

(71) Applicants: Panasonic Holdings Corporation, Osaka (JP); TOYOTA JIDOSHA KABUSHIKI KAISHA, Aichi (JP)

(72) Inventors: Takaaki TAMURA, Osaka (JP); Yasutaka TSUTSUI, Osaka (JP); Tatsuya OSHIMA, Osaka (JP); Akio MITSUI, Anjo-shi (JP)

(21) Appl. No.: 18/955,448

(22) Filed: Nov. 21, 2024

Related U.S. Application Data
(63) Continuation of application No. PCT/JP2023/019564, filed on May 25, 2023.

(30) Foreign Application Priority Data
May 27, 2022 (JP) 2022-087267

(51) Int. Cl. H01M 4/62; H01M 4/131; H01M 10/0525; H01M 10/0562

(52) U.S. Cl. CPC H01M 4/62; H01M 4/131; H01M 4/622; H01M 10/0525; H01M 10/0562; H01M 2300/0068

(57) ABSTRACT

An electrode composition includes an electrode active material, a solid electrolyte, a solvent, and a dispersant. The dispersant includes a first dispersant and a second dispersant. The first dispersant includes at least one selected from the group consisting of phenols and an amino hydroxy compound. The second dispersant includes at least one selected from the group consisting of a nitrogen-containing compound and an alcohol.

This application is a continuation of PCT/JP2023/019564 filed on May 25, 2023, which claims foreign priority of Japanese Patent Application No. 2022-087267 filed on May 27, 2022, the entire contents of both of which are incorporated herein by reference.

### BACKGROUND OF THE INVENTION

### 1. Field of the Invention

The present disclosure relates to an electrode composition and a battery.

### 2. Description of Related Art

Research has been actively made for secondary batteries having a high energy density and high reliability. To obtain such secondary batteries, an electrode composition including an electrode active material and a solid electrolyte each having improved dispersibility is required. Moreover, an electrode composition capable of improving ionic conductivity is required.

According to JP 2016-212990 A, at least one of a positive electrode active material layer, a solid electrolyte layer, and a negative electrode active material layer includes a dispersant. This dispersant is a compound including: a functional group such as a group containing a basic nitrogen atom; and an alkyl group having 8 or more carbon atoms or an aryl group having 10 or more carbon atoms.

According to WO 2020/136975 A1, a battery material including a compound including an imidazoline ring and an aromatic ring, the compound having a molecular weight less than 350.

According to JP 2020-161364 A, a positive electrode produced using a slurry including an acrylic resin binder and 1-hydroxyethyl-2-alkenylimidazoline.

### SUMMARY OF THE INVENTION

As for conventional techniques, reduction in charging resistance of a battery is required.

An electrode composition according to one aspect of the present disclosure includes:
an electrode active material;
a solid electrolyte;
a solvent; and
a dispersant, wherein
the dispersant includes a first dispersant and a second dispersant,
the first dispersant includes at least one selected from the group consisting of phenols and an amino hydroxy compound, and
the second dispersant includes at least one selected from the group consisting of a nitrogen-containing compound and an alcohol.

The present disclosure can provide an electrode composition capable of reducing a charging resistance of a battery.

### BRIEF DESCRIPTION OF THE DRAWINGS

FIG. 1 is a schematic diagram showing an electrode composition of Embodiment 1.

FIG. 2 is a flow chart showing a method for manufacturing an electrode sheet of Embodiment 2.

FIG. 3 is a cross-sectional view showing an electrode assembly of Embodiment 2.

FIG. 4 is a cross-sectional view showing an electrode of Embodiment 2.

FIG. 5 is a cross-sectional view showing an electrode transfer sheet of Embodiment 2.

FIG. 6 is a cross-sectional view showing a battery precursor of Embodiment 2.

FIG. 7 is a cross-sectional view showing a battery of Embodiment 3.

FIG. 8 is a graph showing the results for measuring active material slurries for their viscosities at a shear rate of 100 (1/sec).

### DETAILED DESCRIPTION

### Findings on which the Present Disclosure is Based

In the conventional secondary battery field, an organic electrolyte solution obtained by dissolving an electrolyte salt in an organic solvent is mainly used as an electrolyte. An organic electrolyte solution may leak from a secondary battery. Generation of a large amount of heat by, for example, a short circuit is also a concern.

All-solid-state secondary batteries including an inorganic solid electrolyte instead of an organic electrolyte solution are becoming the focus of attention. All-solid-state secondary batteries do not leak. Additionally, reduction of heat generation by a short circuit, etc. is expected because inorganic solid electrolytes have high thermal stability.

The present inventors studied an electrode composition including a solid electrolyte, an electrode active material, and a dispersant. As a result, the present inventors found that a charging resistance of a battery can be reduced by using a plurality of particular compounds as dispersants in an electrode composition.

### Summary of One Aspect According to the Present Disclosure

An electrode composition according to a first aspect of the present disclosure includes:
an electrode active material;
a solid electrolyte;
a solvent; and
a dispersant, wherein
the dispersant includes a first dispersant and a second dispersant,
the first dispersant includes at least one selected from the group consisting of phenols and an amino hydroxy compound, and
the second dispersant includes at least one selected from the group consisting of a nitrogen-containing compound and an alcohol.

According to the first aspect, an electrode composition capable of reducing a charging resistance of a battery can be provided.

According to a second aspect of the present disclosure, for example, in the electrode composition according to the first aspect, the nitrogen-containing compound may be a compound classified neither as the phenols nor the amino hydroxy compound. Since the phenols and the amino hydroxy compound have a hydroxy group with high acidity, the ionic conductivity of an electrode can be improved by excluding these from the nitrogen-containing compound.

According to a third aspect of the present disclosure, for example, in the electrode composition according to the first or second aspect, the phenols may include at least one selected from the group consisting of a chain alkyl group having 9 or more carbon atoms and a chain alkenyl group having 9 or more carbon atoms.

According to the third aspect, the dispersibility of the electrode active material can be further improved.

According to a fourth aspect of the present disclosure, for example, in the electrode composition according to any one of the first to third aspects, the amino hydroxy compound may include at least one selected from the group consisting of a chain alkyl group having 8 or more carbon atoms and a chain alkenyl group having 8 or more carbon atoms.

According to the fourth aspect, the dispersibility of the electrode active material can be further improved.

According to a fifth aspect of the present disclosure, for example, in the electrode composition according to any one of the first to fourth aspects, the nitrogen-containing compound may be represented by the following chemical formula (1).

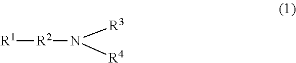

Here, R¹ may include a chain alkyl group having 7 or more and 21 or less carbon atoms or a chain alkenyl group having 7 or more and 21 or less carbon atoms, R² may be —CH₂—, —CO—, or —NH(CH₂)³—, and R³ and R⁴ may each independently be a chain alkyl group having 1 or more and 22 or less carbon atoms, a chain alkenyl group having 1 or more and 22 or less carbon atoms, or a hydrogen atom.

According to the fifth aspect, the dispersibility of the solid electrolyte can be further improved.

According to a sixth aspect of the present disclosure, for example, in the electrode composition according to any one of the first to fifth aspects, the alcohol may include at least one selected from the group consisting of a chain alkyl group having 10 or more carbon atoms and a chain alkenyl group having 10 or more carbon atoms.

According to the sixth aspect, the dispersibility of the solid electrolyte can be further improved. Moreover, a more uniform electrode sheet can be obtained.

According to a seventh aspect of the present disclosure, for example, in the electrode composition according to any one of the first to sixth aspects, the electrode active material may include an oxide.

According to the seventh aspect, the dispersibility of the electrode active material can be further improved by the dispersant including at least one selected from the group consisting of the phenols and the amino hydroxy compound. Moreover, a more uniform electrode sheet can be obtained.

According to an eighth aspect of the present disclosure, for example, in the electrode composition according to any one of the first to seventh aspects, the solid electrolyte may include a sulfide solid electrolyte.

According to the eighth aspect, the dispersibility of the solid electrolyte can be further improved by the dispersant including at least one selected from the group consisting of the nitrogen-containing compound and the alcohol. Moreover, a more uniform electrode sheet can be obtained.

According to a ninth aspect of the present disclosure, for example, in the electrode composition according to any one of the first to eighth aspects, the electrode composition may further include a binder.

According to the ninth aspect, the wettability and the dispersion stability of the solid electrolyte in the solvent can be improved.

According to a tenth aspect of the present disclosure, for example, the electrode composition according to any one of the first to ninth aspects may include at least one selected from the group consisting of a styrene-ethylene/butylene-styrene block copolymer and a styrene-butadiene rubber.

According to the tenth aspect, the styrene-ethylene/butylene-styrene block copolymer (SEBS) and the styrene-butadiene rubber (SBR) are each particularly suitable as a binder for an electrode sheet because of their higher flexibility and elasticity.

According to an eleventh aspect of the present disclosure, for example, in the electrode composition according to the fifth aspect, in the chemical formula (1), R¹ may include at least one selected from the group consisting of a linear alkyl group having 7 or more and 21 or less carbon atoms and an alkenyl group having 7 or more and 21 or less carbon atoms. R² may be —CH₂—. R³ and R⁴ may each independently be —CH₃ or —H.

According to the eleventh aspect, the dispersibility of the solid electrolyte can be further improved, and a more uniform electrode sheet can be obtained.

According to a twelfth aspect of the present disclosure, for example, in the electrode composition according to any one of the first to eleventh aspects, the nitrogen-containing compound may include at least one selected from the group consisting of dimethylpalmitylamine and oleylamine.

According to the twelfth aspect, the dispersibility of the solid electrolyte can be further improved, and a more uniform electrode sheet can be obtained.

According to a thirteenth aspect of the present disclosure, for example, in the electrode composition according to any one of the first to twelfth aspects, the amino hydroxy compound may include 1-hydroxyethyl-2-alkenylimidazoline.

According to the thirteenth aspect, the dispersibility of the electrode active material can be further improved, and a more uniform electrode sheet can be obtained.

According to a fourteenth aspect of the present disclosure, for example, in the electrode composition according to any one of the first to thirteenth aspects, the second dispersant may be a dispersant of a different type from the first dispersant.

According to the fourteenth aspect, the dispersibility of the electrode active material can be further improved, and a more uniform electrode sheet can be obtained.

A battery according to a fifteenth aspect of the present disclosure includes:
a positive electrode;
a negative electrode; and
an electrolyte layer disposed between the positive electrode and the negative electrode, wherein
at least one selected from the group consisting of the positive electrode and the negative electrode includes a dispersant,
the dispersant includes a first dispersant and a second dispersant,
the first dispersant includes at least one selected from the group consisting of phenols and an amino hydroxy compound, and
the second dispersant includes at least one selected from the group consisting of a nitrogen-containing compound and an alcohol.

According to the fifteenth aspect, a battery having a low charging resistance can be obtained.

Embodiments of the present disclosure will be described hereinafter with reference to the drawings. The present disclosure is not limited to the following embodiments.

### Embodiment 1

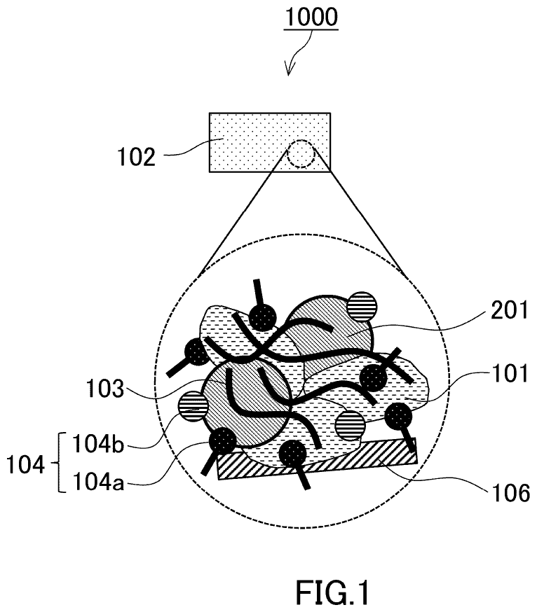

FIG. 1 is a schematic diagram showing an electrode composition 1000 of Embodiment 1. The electrode composition 1000 includes an electrode active material 201, a solid electrolyte 101, a solvent 102, and a dispersant 104. The dispersant 104 includes a first dispersant 104a and a second dispersant 104b. The first dispersant 104a includes at least one selected from the group consisting of phenols and an amino hydroxy compound. The second dispersant 104b includes at least one selected from the group consisting of a nitrogen-containing compound and an alcohol. The electrode composition 1000 may further include a binder 103.

The first dispersant 104a is a dispersant suitable for dispersion of the electrode active material 201. The second dispersant 104b is a dispersant suitable for dispersion of the solid electrolyte 101. The electrode composition 1000 capable of reducing a charging resistance of a battery can be obtained by including these dispersants.

The electrode composition 1000 may include a conductive additive 106. The solid electrolyte 101, the electrode active material 201, the binder 103, the first dispersant 104a, the second dispersant 104b, and the conductive additive 106 are dispersed or dissolved in the solvent 102.

As described above, the electrode composition 1000 includes the first dispersant 104a. The first dispersant 104a includes at least one selected from the group consisting of the phenols and the amino hydroxy compound. Due to the structures of these compounds, hydroxy groups thereof have high polarity, compared to ordinary higher alcohols. Therefore, since the electrode composition 1000 includes the first dispersant 104a, the dispersibility of the electrode active material 201 can be improved.

The electrode composition 1000 includes the second dispersant 104b. The second dispersant 104b includes at least one selected from the group consisting of the nitrogen-containing compound and the alcohol. Although the polarity of each of these compounds is lower than those of the phenols and the amino hydroxy compound, the dispersibility of the solid electrolyte 101 can be improved. Therefore, the second dispersant 104b can allow the solid electrolyte to be dispersed while reducing a decrease of the ionic conductivity of the solid electrolyte. Since the electrode composition 1000 includes the second dispersant 104b, a decrease of the ionic conductivity of the solid electrolyte 101 can be reduced.

The electrode composition 1000 can be a slurry having fluidity. When the electrode composition 1000 has fluidity, it is possible to form an electrode sheet by a wet process such as application.

The electrode sheet may be a self-supporting sheet member, or may be a positive or negative electrode layer supported by a current collector, a substrate, or an electrode assembly.

The electrode composition 1000 will be described hereinafter in details.

### [Electrode Composition]

As described above, the electrode composition 1000 includes the solid electrolyte 101, the electrode active material 201, the first dispersant 104a, the second dispersant 104b, and the solvent 102. The electrode composition 1000 further includes, for example, the binder 103 and the conductive additive 106. The solid electrolyte 101, the electrode active material 201, the binder 103, the first dispersant 104a, the second dispersant 104b, the conductive additive 106, and the solvent 102 will be described hereinafter in details.

### <Solid Electrolyte>

The solid electrolyte 101 may include a sulfide solid electrolyte. When a lithium-containing sulfide solid electrolyte is used as the solid electrolyte 101, a lithium secondary battery can be manufactured using an electrode sheet made from the electrode composition 1000 including the lithium-containing sulfide solid electrolyte.

The solid electrolyte 101 may include a solid electrolyte other than a sulfide solid electrolyte, and may include, for example, an oxide solid electrolyte, a halide solid electrolyte, a polymer solid electrolyte, or a complex hydride solid electrolyte. Alternatively, the solid electrolyte 101 may be a sulfide solid electrolyte. In other words, the solid electrolyte 101 may include a sulfide solid electrolyte only.

In the present disclosure, the term “oxide solid electrolyte” refers to a solid electrolyte including oxygen. An oxide solid electrolyte may further include, as an anion other than oxygen, an anion other than sulfur and a halogen element.

In the present disclosure, the term “halide solid electrolyte” refers to a halogen-containing sulfur-free solid electrolyte. In the present disclosure, the term “sulfur-free solid electrolyte” refers to a solid electrolyte represented by a composition formula free of the sulfur element. Therefore, a solid electrolyte including a very small amount of a sulfur component, such as 0.1 mass % or less sulfur, is classified as a sulfur-free solid electrolyte. A halide solid electrolyte may further include oxygen as an anion other than a halogen element.

For example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like can be used as the sulfide solid electrolyte. LiX, Li₂O, MO_{q}, LiₚMO_{q}, or the like may be added to these. The element X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. The symbols p and q in “MO_{q}” and “LiₚMO_{q}” are each independently a natural number.

For example, a Li₂S—P₂S₅-based glass ceramic may be used as the sulfide solid electrolyte. LiX, Li₂O, MO_{q}, LiₚMO_{q}, or the like may be added to the Li₂S—P₂S₅-based glass ceramic, or two or more selected from LiCl, LiBr, and LiI may be added to the Li₂S—P₂S₅-based glass ceramic. Since the Li₂S—P₂S₅-based glass ceramic is a relatively soft material, a more durable battery can be manufactured using a solid electrolyte sheet including the Li₂S—P₂S₅-based glass ceramic.

As the oxide solid electrolyte can be used, for example, a NASICON solid electrolyte typified by LiTi₂(PO₄)₃ and element-substituted substances thereof; a (LaLi) TiO₃-based perovskite solid electrolyte; a LISICON solid electrolyte typified by Li₁₄ZnGe₄O₁₆, Li₄SiO₄, LiGeO₄ and element-substituted substances thereof; a garnet solid electrolyte typified by Li₇La₃Zr₂O₁₂ and element-substituted substances thereof; Li₃PO₄ and N-substituted substances thereof; or a glass or glass ceramic including a Li—B—O compound such as LiBO₂ or LisBO₃ as a base and Li₂SO₄, Li₂CO₃, or the like added thereto.

The halide solid electrolyte includes, for example, Li, M1, and X. The symbol M1 is at least one selected from the group consisting of a metal element other than Li and a metalloid element. The symbol X is at least one selected from the group consisting of F, Cl, Br, and I. Since having high thermal stability, the halide solid electrolyte can improve the safety of a battery. Furthermore, since free of sulfur, the halide solid electrolyte can reduce generation of hydrogen sulfide gas.

In the present disclosure, “metalloid elements” are B, Si, Ge, As, Sb, and Te.

In the present disclosure, “metal elements” are all elements included in Groups 1 to 12 of the periodic table except hydrogen and all elements included in Groups 13 to 16 of the periodic table except B, Si, Ge, As, Sb, Te, C, N, P, O, S, and Se.

That is, in the present disclosure, the terms “metalloid elements” and “metal elements” each refer to a group of elements that can become cations when forming an inorganic compound with a halogen element.

For example, the halide solid electrolyte may be a material represented by the following composition formula (2A).

Li_{α}M1_{β}X_{γ} Formula (2A)

In the above composition formula (2A), α, β, and γ are each independently a value greater than 0. The symbol γ can be, for example, 4 or 6.

The halide solid electrolyte configured as above has an improved ionic conductivity, which can improve the ionic conductivity of an electrode sheet formed from the electrode composition 1000 of Embodiment 1. When this electrode sheet is included in a battery, cycle characteristics of the battery can further be improved.

In the above composition formula (2A), the element M1 may include Y (=yttrium). That is, the halide solid electrolyte may include Y as a metal element.

The Y-containing halide solid electrolyte may be represented, for example, by the following composition formula (2B).

LiₐMe_{b}Y_{c}X₆ Formula (2B)

In the formula (2B), a, b, and c may satisfy a+mb+3c=6 and c>0. The element Me is at least one selected from the group consisting of metalloid elements and metal elements other than Li and Y. The symbol m represents the valence of the element Me. When the element Me includes a plurality of elements, mb represents a sum of products each determined for one of the elements by multiplying a proportion of the element to the other element(s) and the valence of the element. For example, when Me includes elements Me1 and Me2, mb is represented by m₁b₁+m₂b₂, where the proportion of the element Me1 to the element Me2 is b₁, the valence of the element Me1 is m₁, the proportion of the element Me2 to the element Me1 is b₂, and the valence of the element Me2 is m₂. In the above composition formula (2B), the element X is at least one selected from the group consisting of F, Cl, Br, and I.

The element Me may be, for example, at least one selected from the group consisting of Mg, Ca, Sr, Ba, Zn, Sc, Al, Ga, Bi, Zr, Hf, Ti, Sn, Ta, Gd, and Nb.

For example, any of the following materials can be used as the halide solid electrolyte. Since the following materials further improve the ionic conductivity of the solid electrolyte 101, the ionic conductivity of an electrode sheet formed from the electrode composition 1000 can be improved. This electrode sheet can further improve cycle characteristics of a battery.

The halide solid electrolyte may be a material represented by the following composition formula (A1).

Li_{6-3d}Y_{d}X₆ Formula (A1)

In the composition formula (A1), the element X is at least one selected from the group consisting of Cl, Br, and I. In the composition formula (A1), d satisfies 0<d<2. The halide solid electrolyte may be a material represented by the following composition formula (A2).

Li₃YX₆ Formula (A2)

In the composition formula (A2), the element X is at least one selected from the group consisting of Cl, Br, and I.

The halide solid electrolyte may be a material represented by the following composition formula (A3).

$${Li}_{3 - 3 δ} {Y}_{1 + δ} {Cl}_{6} \qquad Formula ( A3 )$$

In the composition formula (A3), δ satisfies 0<δ≤0.15.

The halide solid electrolyte may be a material represented by the following composition formula (A4).

$${Li}_{3 - 3 δ} {Y}_{1 + δ} {Br}_{6} \qquad Formula ( A4 )$$

In the composition formula (A4), δ satisfies 0<δ≤0.25.

The halide solid electrolyte may be a material represented by the following composition formula (A5).

$${Li}_{3 - 3 δ + a} {Y}_{1 + δ - a} {Me}_{a} {Cl}_{6 - x - y} {Br}_{x} {I}_{y} \qquad Formula ( A5 )$$

In the composition formula (A5), the element Me is at least one selected from the group consisting of Mg, Ca, Sr, Ba, and Zn.

Furthermore, in the above composition formula (A5),

$$- 1 < δ < 2 ,$$

$$0 < a < 3 ,$$

$$0 < ( 3 - 3 δ + a ) ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a material represented by the following composition formula (A6).

$${Li}_{3 - 3 δ} {Y}_{1 + δ - a} {Me}_{a} {Cl}_{6 - x - y} {Br}_{x} {I}_{y} \qquad Formula ( A6 )$$

In the composition formula (A6), the element Me is at least one selected from the group consisting of A1, Sc, Ga, and Bi.

Furthermore, in the above composition formula (A6),

$$- 1 < δ < 1 ,$$

$$0 < a < 2 ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a material represented by the following composition formula (A7).

$${Li}_{3 - 3 δ - a} {Y}_{1 + δ - a} {Me}_{a} {Cl}_{6 - x - y} {Br}_{x} {I}_{y} \qquad Formula ( A7 )$$

In the above composition formula (A7), the element Me is at least one selected from the group consisting of Zr, Hf, and Ti.

Furthermore, in the above composition formula (A7),

$$- 1 < δ < 1 ,$$

$$0 < a < 1.5 ,$$

$$0 < ( 3 - 3 δ - a ) ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a material represented by the following composition formula (A8).

$${Li}_{3 - 3 δ - 2 a} {Y}_{1 + δ - a} {Me}_{a} {Cl}_{6 - x - y} {Br}_{x} {I}_{y} \qquad Formula ( A8 )$$

In the composition formula (A8), the element Me is at least one selected from the group consisting of Ta and Nb.

Furthermore, in the above composition formula (A8),

$$- 1 < δ < 1 ,$$

$$0 < a < 1.2 ,$$

$$0 < ( 3 - 3 δ - 2 a ) ,$$

$$0 < ( 1 + δ - a ) ,$$

$$0 \leq x \leq 6 ,$$

$$0 \leq y \leq 6 , and$$

$$( x + y ) \leq 6$$

are satisfied.

The halide solid electrolyte may be a compound including Li, M2, O (oxygen), and X2. The element M2 includes, for example, at least one selected from the group consisting of Nb and Ta. The element X2 is at least one selected from the group consisting of F, Cl, Br, and I.

The compound including Li, M2, X2, and O (oxygen) may be represented, for example, by a composition formula LiₓM2O_{y}X2_{5+x-2y}. Here, x may satisfy 0.1<x<7.0. The symbol y may satisfy 0.4<y<1.9.

Moe specifically, for example, Li₃Y(Cl, Br, I)₆, Li_{2.7}Y_{1.1}(Cl, Br, I)₆, Li₂Mg(F,Cl,Br,I)₄, Li₂Fe(F,Cl, Br,I)₄, Li(Al, Ga, In)(F, Cl, Br, I)₄, Li₃(Al, Ga, In)(F,Cl,Br,I)₆, Li₃(Ca, Y,Gd)(Cl,Br,I)₆, Li_{2.7}(Ti,Al)F₆, Li_{2.5}(Ti, Al)F₆, Li(Ta, Nb)O(F,Cl)₄, or the like can be used as the halide solid electrolyte. Note that, in the present disclosure, when an element in a formula is expressed by, for example, “(Al, Ga, In)”, this expression indicates at least one element selected from the group of elements in the parentheses. In other words, the expression “(Al, Ga, In)” is synonymous with the expression “at least one selected from the group consisting of Al, Ga, and In”. The same applies to other elements.

For example, a compound of a polymer compound and a lithium salt can be used as the polymer solid electrolyte. The polymer compound may have an ethylene oxide structure. The polymer compound having an ethylene oxide structure can contain a large amount of a lithium salt. Therefore, the polymer compound having an ethylene oxide structure can further improve the ionic conductivity. As the lithium salt can be used LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. One lithium salt may be used alone, or two or more lithium salts may be used in combination.

For example, LiBH₄—LiI or LiBH₄—P₂S₅ can be used as the complex hydride solid electrolyte.

The shape of the solid electrolyte 101 is not limited to a particular one, and may be the shape of a needle, a sphere, an ellipsoid, or the like. The solid electrolyte 101 may have the shape of a particle.

When the solid electrolyte 101 has the shape of a particle (e.g., a sphere), the median diameter of the solid electrolyte 101 may be 1 μm or more and 100 μm or less, or 1 μm or more and 10 μm or less. When the solid electrolyte 101 has a median diameter of 1 μm or more and 100 μm or less, the solid electrolyte 101 can be easily dispersed in the solvent 102.

When the solid electrolyte 101 has the shape of a particle (e.g., a sphere), the median diameter of the solid electrolyte 101 may be 0.1 μm or more and 5 μm or less, or 0.5 μm or more and 3 μm or less. When the solid electrolyte 101 has a median diameter of 0.1 μm or more and 5 μm or less, an electrode sheet manufactured using the electrode composition 1000 can have higher surface smoothness and a denser structure.

The term “median diameter” means a particle size at 50% in a volume-based cumulative particle size distribution. The volume-based particle size distribution can be determined by a laser diffraction scattering method. The same applies to other materials.

The solid electrolyte 101 may have a specific surface area of 0.1 m²/g or more and 100 m²/g or less, or 1 m²/g or more and 10 m²/g or less. When the solid electrolyte 101 has a specific surface area of 0.1 m²/g or more and 100 m²/g or less, the solid electrolyte 101 can be easily dispersed in the solvent 102. The specific surface area can be measured by a multi-point BET method using an adsorbed gas amount measurement apparatus.

The solid electrolyte 101 may have an ionic conductivity of 0.01 mS/cm² or more, 0.1 mS/cm² or more, or 1 mS/cm² or more. When the solid electrolyte 101 has an ionic conductivity of 0.01 mS/cm² or more, output characteristics of a battery can be improved.

### <Binder>

In the electrode composition 1000, the binder 103 can improve the wettability and the dispersion stability of the solid electrolyte 101 in the solvent 102. The binder 103 can improve the adhesiveness between the particles of the solid electrolyte 101 in a solid electrolyte sheet. In the electrode composition 1000, for example, the particles of the solid electrolyte 101 are bonded to each other via the binder 103.

The binder 103 includes a styrene elastomer. The styrene elastomer means an elastomer including a repeating unit derived from styrene. A repeating unit refers to a molecular structure derived from a monomer, and is sometimes called a structural unit. The styrene elastomer is suitable as the binder for a solid electrolyte sheet because of its excellent flexibility and elasticity. A percentage of the repeating unit derived from styrene in the styrene elastomer is, for example, but not particularly limited to, 10 mass % or more and 70 mass % or less.

The styrene elastomer may be a block copolymer including a first block formed of the repeating unit derived from styrene and a second block formed of a repeating unit derived from a conjugated diene. Examples of the conjugated diene include butadiene and isoprene. The repeating unit derived from the conjugated diene may be hydrogenated. That is, the repeating unit derived from the conjugated diene may include or does not necessarily need to include an unsaturated bond such as a carbon-carbon double bond. The block copolymer may have a block sequence of a triblock composed of two first blocks and one second block. The block copolymer may be an ABA triblock copolymer. In this triblock copolymer, an A block corresponds to the first block, and a B block corresponds to the second block. The first block functions, for example, as a hard segment. The second block functions, for example, as a soft segment.

Examples of the styrene elastomer include a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene rubber (SBR), a styrene-butadiene-styrene block copolymer (SBS), a styrene-isoprene-styrene block copolymer (SIS), and a hydrogenated styrene-butadiene rubber (HSBR). The binder 103 may include SBR or SEBS as the styrene elastomer. A mixture including two or more selected from these may be used as the binder 103. The dispersion stability and the fluidity of the electrode composition 1000 can be improved by the binder 103 including the styrene elastomer because the styrene elastomer has high flexibility and high elasticity. Moreover, the binder 103 including the styrene elastomer can improve the surface smoothness of an electrode sheet manufactured using the electrode composition 1000. Furthermore, the binder 103 including the styrene elastomer can impart flexibility to a solid electrolyte sheet. These allow an electrolyte layer of a battery including the solid electrolyte sheet to have a reduced thickness, so that the energy density of the battery can be improved.

The styrene elastomer may be a styrene triblock copolymer. Examples of the styrene triblock copolymer include a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene-styrene block copolymer (SBS), and a styrene-isoprene-styrene block copolymer (SIS). These styrene triblock copolymers are sometimes called styrene thermoplastic elastomers. These styrene triblock copolymers are flexible, and tend to have high strength.

The binder 103 may include the styrene elastomer. The styrene elastomer may include at least one selected from the group consisting of a styrene-ethylene/butylene-styrene block copolymer (SEBS) and a styrene-butadiene rubber (SBR). The SEBS and the SBR are particularly suitable as a binder for an electrode sheet because of their excellent flexibilities and elasticities and their excellent filling properties exhibited at the time of thermal compression.

The styrene elastomer may include a modified group. The term “modified group” refers to a functional group chemically modifying every repeating unit included in a polymer chain, a part of repeating units included in a polymer chain, or a terminal of a polymer chain. The modified group can be introduced into a polymer chain by a substitution reaction, an addition reaction, or the like. The modified group includes, for example, an element such as O, N, S, F, Cl, Br, or F having a relatively high electronegativity or Si, Sn, or P having a relatively low electronegativity. The modified group including any of these elements can polarize the polymer. Examples of the modified group include a carboxylic acid group, an acid anhydride group, an acyl group, a hydroxy group, a sulfo group, a sulfanyl group, a phosphate group, a phosphonate group, an isocyanate group, an epoxy group, a silyl group, an amino group, a nitrile group, and a nitro group. Specific examples of the acid anhydride group include a maleic anhydride group. The modified group may be a functional group that can be introduced by a reaction of a modifying agent formed of any of the following compounds. Examples of the compound forming the modifying agent include an epoxy compound, an ether compound, an ester compound, an isoisocyanate compound, an isothioisocyanate compound, an isocyanuric acid derivative, a nitrogen-group-containing carbonyl compound, a nitrogen-group-containing vinyl compound, a nitrogen-group-containing epoxy compound, a mercapto group derivative, a thiocarbonyl compound, an isothioisocyanate compound, a halogenated silicon compound, an epoxidized silicon compound, a vinylated silicon compound, an alkoxy silicon compound, a nitrogen-group-containing alkoxy silicon compound, a halogenated tin compounds, an organic tincarboxylate compound, a phosphite ester compound, and a phosphino compound. In the case where the styrene elastomer in the binder 103 includes the above modified group, the dispersibility of the solid electrolyte 101 included in the electrode composition 1000 can be further improved. Moreover, in that case, the peeling strength of an electrode sheet can be improved by an interaction with a current collector.

The styrene elastomer may include a nitrogen-atom-containing modified group. The nitrogen-atom-containing modified group is a nitrogen-containing functional group, and is, for example, an amino group such as an amine compound. The modified group may be located at a terminal of the polymer chain. The styrene elastomer having the modified group at a terminal of the polymer chain can have an effect similar to that of what is called a surfactant. That is, by using the styrene elastomer having the modified group at a terminal of the polymer chain, the modified group is adsorbed to the solid electrolyte 101 and thus the polymer chain can reduce aggregation of the particles of the solid electrolyte 101. Consequently, the dispersibility of the solid electrolyte 101 can be improved further. The styrene elastomer may be, for example, a terminal-amine-modified styrene elastomer. The styrene elastomer may be, for example, a styrene elastomer containing a nitrogen atom at at least one terminal of the polymer chain and having a star-shaped polymer structure having a nitrogen-containing alkoxysilane substituent at its center.

The styrene elastomer may have a weight-average molecular weight (Mw) of 200,000 or more. The weight-average molecular weight of the styrene elastomer may be 300,000 or more, 500,000 or more, 800,000 or more, or 1,000,000 or more. The upper limit of the weight-average molecular weight is, for example, 1,500,000. When the weight-average molecular weight of the styrene elastomer is 200,000 or more, the particles of the solid electrolyte 101 can be adhered to each other with a sufficient bond strength. When the weight-average molecular weight of the styrene elastomer is 1,500,000 or less, ionic conduction between the particles of the solid electrolyte 101 is not likely to be impeded by the binder 103 and output characteristics of a battery can be improved. The weight-average molecular weight of the styrene elastomer can be determined, for example, by gel permeation chromatography (GPC) using polystyrene as a standard specimen. In other words, the weight-average molecular weight is a value calculated in terms of polystyrene. Chloroform may be used as an eluent in the GPC. If two or more peak tops are confirmed in a chart obtained by the GPC, a weight-average molecular weight calculated from an overall peak range including the peak tops can be considered as the weight-average molecular weight of the styrene elastomer.

As for the styrene elastomer, a ratio of a degree of polymerization of the repeating unit derived from styrene and a degree of polymerization of a repeating unit derived from a compound other than styrene is defined as min. In this case, the molar fraction (φ) of the repeating unit derived from styrene in the styrene elastomer can be calculated by φ=m/(m+n). The molar fraction (φ) of the repeating unit derived from styrene in the styrene elastomer can be determined, for example, by proton nuclear magnetic resonance (¹H NMR).

In the styrene elastomer, the molar fraction (φ) of the repeating unit derived from styrene may be 0.05 or more and 0.55 or less, or 0.1 or more and 0.3 or less. When the molar fraction φ of the styrene elastomer is 0.05 or more, the strength of an electrode sheet can be improved. When the molar fraction φ in the styrene elastomer is 0.55 or less, the flexibility of an electrode sheet can be improved.

The binder 103 may include a binder other than the styrene elastomer, the binder being, for example, a binder that can commonly be used as a binder for batteries. Alternatively, the binder 103 may be the styrene elastomer. In other words, the binder 103 may include the styrene elastomer only.

Examples of the binder include polyvinylidene fluoride (PVDF), polytetrafluoroethylene (PTFE), polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester (PMMA), polymethacrylic acid ethyl ester, polymethacrylic acid hexyl ester, polyvinyl acetate, polyvinylpyrrolidone, polyether, polycarbonate, polyethersulfone, polyetherketone, polyetheretherketone, polyphenylene sulfide, hexafluoropolypropylene, styrene-butadiene rubber, carboxymethyl cellulose, and ethyl cellulose. As the binder can be used a copolymer synthesized using two or more monomers selected from the group consisting of tetrafluoroethylene, hexafluoroethylene, hexafluoropropylene, perfluoroalkylvinyl ether, vinylidene fluoride, chlorotrifluoroethylene, ethylene, propylene, butadiene, isoprene, styrene, pentafluoropropylene, fluoromethyl vinyl ether, acrylic acid ester, acrylic acid, and hexadiene. One of these may be used alone, or two or more of these may be used in combination.

The binder may include an elastomer in terms of its excellent binding properties. Elastomers refer to polymers having rubber elasticity. The elastomer used as the binder may be a thermoplastic elastomer or a thermosetting elastomer. Examples of the elastomer include butadiene rubber (BR), isoprene rubber (IR), chloroprene rubber (CR), acrylonitrile-butadiene rubber (NBR), hydrogenated isoprene rubber (HIR), hydrogenated butyl rubber (HIIR), hydrogenated nitrile rubber (HNBR), and acrylate butadiene rubber (ABR) in addition to the above-described styrene elastomer. A mixture including two or more selected from these may be used.

### <Dispersant>

The dispersant 104 includes the first dispersant 104a and the second dispersant 104b.

### <First Dispersant>

The first dispersant 104a can improve the dispersibility of the electrode active material 201. The first dispersant 104a includes at least one selected from the group consisting of the phenols and the amino hydroxy compound.

### <Phenols>

The term “phenols” herein means a compound in which one hydrogen atom or a plurality of hydrogen atoms in an aromatic ring are each substituted by a hydroxy group. The aromatic ring may be a benzene ring. The phenols may be a compound in which a hydrogen atom in the benzene ring of phenol is substituted by a hydrocarbon group. That is, the phenols may be a compound represented by the following chemical formula (3).

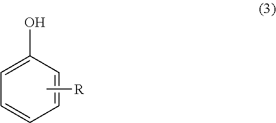

In the chemical formula (3), R is an alkyl group or an alkenyl group. The symbol R may be a chain alkyl group having 9 or more carbon atoms or a chain alkenyl group having 9 or more carbon atoms. The chain alkyl group is a substituent composed of an aliphatic saturated hydrocarbon in which atoms other than hydrogen atoms, namely carbon atoms, are linked to one another without a ring. The chain alkyl group may be a linear alkyl group or a branched alkyl group. The number of Rs is not particularly limited. A position where R is bonded is not limited to a particular position, either. The position where R is bonded may be an ortho position, a meta position, or a para position. The phenols may be a mixture of these isomers.

The number of hydroxy groups included in the phenols is not particularly limited, and may be one or may be two or more.

As described above, the phenols may include at least one selected from the group consisting of a chain alkyl group having 9 or more carbon atoms and a chain alkenyl group having 9 or more carbon atoms. In the chemical formula (3), R may include at least one selected from the group consisting of a chain alkyl group having 9 or more carbon atoms and a chain alkenyl group having 9 or more carbon atoms. In this case, the dispersibility of the electrode active material can be further improved.

The phenols may include a linear alkyl group having 9 or more carbon atoms. The linear alkyl group is a substituent composed of an aliphatic saturated hydrocarbon in which atoms other than hydrogen atoms, namely carbon atoms, are linked to one another without a branch.

The phenols may include a linear alkenyl group having 9 or more carbon atoms. The linear alkenyl group is a substituent composed of an aliphatic unsaturated hydrocarbon in which atoms other than hydrogen atoms, namely carbon atoms, are linked to one another without a branch. A position of an unsaturated bond in the alkenyl group is not limited to a particular position. The number of unsaturated bonds in the alkenyl group is not particularly limited, and may be 1 to 3.

In the phenols, the number of carbon atoms included in the chain alkyl group or the chain alkenyl group may be 9 or more and 30 or less, 9 or more and 24 or less, 9 or more and 20 or less, or 9 or more and 18 or less. In these cases, the dispersibility of the electrode active material 201 can be further improved.

The phenols may be free of a nitrogen atom. In the chemical formula (3), R may be free of a nitrogen atom.

The phenols may include an organic substance derived from a natural oil or fat. The phenols may be an organic substance derived from a natural oil or fat. In the phenols, the alkyl group or the alkenyl group may be an alkyl group derived from a natural oil or fat or an alkenyl group derived from a natural oil or fat. Examples of the alkyl group derived from a natural oil or fat and the alkenyl group derived from a natural oil or fat include a cocoalkyl group, a tallow alkyl group, a hydrogenated tallow alkyl group, and an oleyl group (a linear alkenyl group having 18 carbon atoms). The cocoalkyl group includes a linear alkyl group having 8 or more and 18 or less carbon atoms and a linear alkenyl group having 8 or more and 18 or less carbon atoms. The tallow alkyl group includes a linear alkyl group having 14 or more and 18 or less carbon atoms and a linear alkenyl group having 8 or more and 18 or less carbon atoms. The hydrogenated tallow alkyl group includes a linear alkyl group having 14 or more and 18 or less carbon atoms.

Examples of the phenols include 4-nonylphenol, 2,6-di-tert-butyl-4-nonylphenol, 4-dodecylphenol, 2-dodecylphenol, 4-dodecyl-o-cresol, 2-dodecyl-p-cresol, 3-pentadecylphenol, 4-octadecylphenol, cardanol, cardol, 2-methylcardol, and urushiol.

The phenols may be a commercially-available product. For example, a commercially-available reagent, dispersant, wetting agent, or surfactant may be used as the phenols.

### <Amino Hydroxy Compound>

The amino hydroxy compound is a compound having at least one nitrogen atom and at least one hydroxy group in a molecule. By using the amino hydroxy compound, the dispersibility of the electrode active material 201 can be improved further.

The amino hydroxy compound may include a structure represented by the following formula (4).

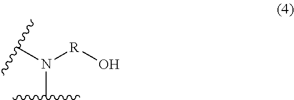

In the formula (4), —R—OH is —(CH₂) n-OH or —(CH₂CH₂O)ₘ—H. The symbol n in —(CH₂)ₙ—OH, namely the number of carbon atoms in the alkylene group, may be 2 or more and 6 or less, 2 or more and 4 or less, or 2. The symbol m may be 1 or more and 5 or less, or 1 or more and 2 or less. In the formula (4), a wavy line indicates a bonding point.

The amino hydroxy compound may include at least one selected from the group consisting of a chain alkyl group having 8 or more and 30 or less carbon atoms and a chain alkenyl group having 8 or more and 30 or less carbon atoms. In this case, the dispersibility of the electrode active material 201 can be further improved. In the amino hydroxy compound, the number of carbon atoms in the chain alkyl group or the chain alkenyl group may be 12 or more and 24 or less, or 16 or more and 22 or less.

The amino hydroxy compound may be an alkanolamine. The alkanolamine is a compound having an amino group (—NH₂) and a hydroxy group (—OH) in a molecule. The alkanolamine compound may be a compound in which hydrogen atoms in an alkane are substituted by an amino group and a hydroxy group, or may be a compound in which hydrogen atoms in an alkene are substituted by an amino group and a hydroxy group. Even when the alkanolamine compound is used as the first dispersant 104a, the dispersibility of the electrode active material 201 can be further improved.

Examples of the amino hydroxy compound include polyoxyethylene alkylamine, polyoxyethylene alkenylamine, N,N-bis(2-hydroxyethyl)alkylamine, N,N-bis(2-hydroxyethyl)alkenylamine, N,N′,N′-tris(2-hydroxyethyl)-N-alkyl-1,3-diaminopropane, N,N′,N′-tris(2-hydroxyethyl)-N-alkenyl-1,3-diaminopropane, triethanolamine mono-fatty acid ester, triethanolamine di-fatty acid ester, N, N-bis(2-hydroxyethyl) oleylamine, and 1-hydroxyethyl-2-alkenylimidazoline.

The amino hydroxy compound may include a linear alkenyl group. The crystallinity of a compound including a linear alkenyl group tends to be lower than that of a compound including a linear alkyl group only and that of a compound free of a linear alkenyl group. Therefore, the fluidity of the electrode composition 1000 can be further improved by using the amino hydroxy compound including a linear alkenyl group having an unsaturated bond.

The amino hydroxy compound may be a commercially-available product. For example, a commercially-available reagent, dispersant, wetting agent, or surfactant may be used as the amino hydroxy compound.

Polyoxyethylene alkylamine or polyoxyethylene alkenylamine may be used as the amino hydroxy compound. An alkyl group included in the polyoxyethylene alkylamine and an alkenyl group included in the polyoxyethylene alkenylamine may be respectively the alkyl group derived from a natural oil or fat and the alkenyl group derived from a natural oil or fat mentioned above. The average number of moles added of an ethyleneoxide included in the polyoxyethylene alkylamine or the polyoxyethylene alkenylamine may be one or may be two. The alkyl group in the polyoxyethylene alkylamine may have 8 or more and 22 or less carbon atoms. The alkenyl group in the polyoxyethylene alkenylamine may have 8 or more and 22 or less carbon atoms. Examples of the polyoxyethylene alkylamine and the polyoxyethylene alkenylamine include AMIET manufactured by Kao Corporation, LIPONOL manufactured by LION SPECIALTY CHEMICALS CO., LTD., and NYMEEN manufactured by NOF CORPORATION. “AMIET” is a registered trademark of Kao Corporation. “LIPONOL” is a registered trademark of LION SPECIALTY CHEMICALS CO., LTD. “NYMEEN” is a registered trademark of NOF CORPORATION.

Triethanolamine di-fatty acid ester may be used as the amino hydroxy compound. Triethanolamine di-fatty acid ester is a compound formed by esterification of triethanolamine and two fatty acids. The type of fatty acid included in triethanolamine di-fatty acid ester is not limited to a particular one, and a fatty acid including a hydrocarbon group having 16 or more and 18 or less carbon atoms is used. Examples of the fatty acid include palmitic acid, oleic acid, linoleic acid, and linolenic acid. Examples of triethanolamine di-fatty acid ester include DISPERBYK-108 manufactured by BYK. “DISPERBYK” is a registered trademark of BYK.

N, N-Bis(2-hydroxyethyl)alkenylamine may be used as the amino hydroxy compound. An alkenyl group therein may have 10 or more and 22 or less carbon atoms, or 14 or more and 20 or less carbon atoms. The number of unsaturated bonds included in the alkenyl group is not particularly limited, and may be one or may be two.

1-Hydroxyethyl-2-alkenylimidazoline may be used as the amino hydroxy compound. An alkenyl group in 1-hydroxyethyl-2-alkenylimidazoline may be an alkenyl group having 13 or more and 17 or less carbon atoms. The number of unsaturated bonds included in the alkenyl group may be 1 or more and 3 or less. Examples of 1-hydroxyethyl-2-alkenylimidazoline include DISPERBYK-109 manufactured by BYK and HOMOGENOL L-95 manufactured by Kao Corporation. “HOMOGENOL” is a registered trademark of Kao Corporation.

### <Second Dispersant>

The second dispersant 104b can improve the dispersibility of the solid electrolyte 101. The second dispersant 104b includes at least one selected from the group consisting of the nitrogen-containing compound and the alcohol.

### <Nitrogen-Containing Compound>

The nitrogen-containing compound is an organic compound including a nitrogen atom (N). The nitrogen-containing compound may be free of a hydroxy group. The nitrogen-containing compound may be an amine or an amide. The amine may be a compound in which at least one hydrogen atom in ammonia is substituted by a hydrocarbon group. The amide may be a compound in which a hydrogen atom in ammonia or an amine is substituted by an acyl group. Examples of the amine include primary amines, secondary amines, and tertiary amines. The amine may be free of a hydroxy group. The amide may be free of a hydroxy group.

The nitrogen-containing compound may be a compound classified neither as the phenols nor the amino hydroxy compound. The nitrogen-containing compound as the second dispersant may be a compound represented by a chemical formula different from that of the first dispersant. The ionic conductivity of an electrode can be improved by excluding the phenols and the amino hydroxy compound, which have a hydroxy group with high acidity, from the nitrogen-containing compound.

The nitrogen-containing compound may be a compound represented by the following chemical formula (1).

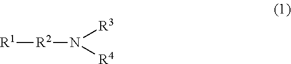

In the chemical formula (1), R¹ is a chain alkyl group having 7 or more and 21 or less carbon atoms or a chain alkenyl group having 7 or more and 21 or less carbon atoms. The symbol R² is —CH₂—, —CO—, or —NH(CH₂)₃—. The symbols R³ and R⁴ are each independently a chain alkyl group having 1 or more and 22 or less carbon atoms, a chain alkenyl group having 1 or more and 22 or less carbon atoms, or a hydrogen atom.

In the above chemical formula (1), R¹ may be a chain alkyl group having 7 or more and 21 or less carbon atoms. The chain alkyl group may be a linear alkyl group or a branched alkyl group.

In the above chemical formula (1), R¹ may be a chain alkenyl group having 7 or more and 21 or less carbon atoms. A position of an unsaturated bond in the chain alkenyl group is not limited to a particular position. The number of unsaturated bonds included in the alkenyl group is not particularly limited, and may be one or may be two. The chain alkenyl group may be a linear alkenyl group or a branched alkenyl group.

In the above chemical formula (1), R² may be —CH₂—. In the above chemical formula (1), when R² is —CH₂—, the compound represented by the chemical formula (1) is an amine. Amines have lower melting points than those of amides. Therefore, the solid electrolyte 101 and the electrode active material 201 can exhibit improved filling properties at the time of thermal pressure molding.

In the above chemical formula (1), R² may be —CO—. That is, R² may be a carbonyl group. In the above chemical formula (1), when R² is —CO—, the compound represented by the chemical formula (1) is an amide. Amides have higher polarities than those of amines. Therefore, the dispersibility of the electrode active material 201 as well as that of the solid electrolyte 101 can be improved.

In the above chemical formula (1), R² may be —NH(CH₂) 3—. In this case, the nitrogen-containing organic substance is a diamine. The diamine can further improve the dispersibility of the solid electrolyte 101.

In the above chemical formula (1), raw materials of R¹ and R² may be natural oil or fats. That is, R¹ and R² may be an alkyl group derived from a natural oil or fat or an alkenyl group derived from a natural oil or fat. Examples of the alkyl group derived from a natural oil or fat and the alkenyl group derived from a natural oil or fat are as described above.

In the above chemical formula (1), R³ and R⁴ may each independently be a chain alkyl group having 1 or more and 22 or less carbon atoms or a chain alkenyl group having 1 or more and 22 or less carbon atoms. In the chemical formula (1), the chain alkyl group bonded to the nitrogen atom and the chain alkenyl group bonded to the nitrogen atom can decrease the nucleophilicity and the basicity of the nitrogen-containing compound. Consequently, a reaction between the second dispersant 104b and the solid electrolyte 101 is reduced, and excessive adsorption between the second dispersant 104b and the solid electrolyte 101 is reduced. The number of carbon atoms included in each the alkyl group and the alkenyl group may be 1 or more and 18 or less, or 1 or more and 16 or less. The chain alkyl group may be a linear alkyl group or a branched alkyl group. The chain alkenyl group may be a linear alkenyl group or a branched alkenyl group.

In the above chemical formula (1), R³ and R⁴ may each independently be —CH₃ or —H. In the chemical formula (1), steric hindrance involving the substituents bonded to the nitrogen atom is reduced, and thus the dispersibility of the solid electrolyte 101 can be further improved.

In the above chemical formula (1), R³ and R⁴ may be —CH₃. When R³ and R⁴ are —CH₃, the second dispersant 104b is a tertiary amine. Since tertiary amines have lower melting points than those of primary amines, the solid electrolyte 101 and the electrode active material 201 can exhibit improved filling properties at the time of pressure molding.

In the above chemical formula (1), R¹ may include at least one selected from the group consisting of a linear alkyl group having 7 or more and 21 or less carbon atoms and a linear alkenyl group having 7 or more and 21 or less carbon atoms. The symbol R² may be —CH₂—. The symbols R³ and R⁴ may each independently be —CH₃ or —H. The second dispersant 104b having the above composition can allow the solid electrolyte 101 to be dispersed better.

Examples of the nitrogen-containing compound include octylamine, dodecylamine, laurylamine, myristyl amine, cetylamine, stearylamine, oleylamine, cocoalkylamine, tallowalkylamine, hydrogenated tallow alkylamine, soyaalkylamine, N-methyloctadecylamine, di hydrogenated tallowalkylamine, di-cocoalkylamine, dimethyloctylamine, dimethyldecylamine, dimethyllaurylamine, dimethylmyristylamine, dimethylpalmitylamine, dimethylstearylamine, dimethylbehenylamine, cocoalkyl dimethylamine, tallowalkyl dimethylamine, hydrogenated tallowalkyl dimethylamine, soyaalkyl dimethylamine, di hydrogenated tallowalkyl methylamine, dioleylmethylamine, didecylmethylamine, trioctylamine, N-cocoalkyl-1,3-diaminopropane, N-tallowalkyl-1,3-diaminopropane, N-hydrogenated tallowalkyl-1,3-diaminopropane, oleyl propylenediamine, behenyl propylenediamine, stearic acid amide, oleic acid amide, and erucic acid amide.

The nitrogen-containing compound may be a commercially-available product. For example, a commercially-available reagent, dispersant, wetting agent, or surfactant may be used as the nitrogen-containing compound.

The nitrogen-containing compound may include at least one selected from the group consisting of dimethylpalmitylamine and oleylamine.

The nitrogen-containing compound may include dimethylpalmitylamine. The nitrogen-containing compound may be dimethylpalmitylamine. Dimethylpalmitylamine is liquid at ordinary temperature. Additionally, dimethylpalmitylamine is a tertiary amine compound having a long-chain alkyl group. Dimethylpalmitylamine can improve the dispersibility of the solid electrolyte 101 further. Moreover, by using dimethylpalmitylamine, the solid electrolyte 101 and the electrode active material 201 can exhibit further improved filling properties at the time of pressure molding.

The amine may include oleylamine. The amine may be oleylamine. Oleylamine is liquid at ordinary temperature. Additionally, oleylamine is a primary amine having a long-chain alkenyl group. Oleylamine can improve the dispersibility of the solid electrolyte 101 further. Moreover, by using oleylamine, the solid electrolyte 101 and the electrode active material 201 can exhibit further improved filling properties at the time of pressure molding.

The nitrogen-containing compound does not necessarily need to have a ring structure. Examples of the ring structure include a heterocycle. Examples of the heterocycle include imidazoline.

### <Alcohol>

The alcohol is a compound in which at least one hydrogen atom in an aliphatic hydrocarbon or an alicyclic hydrocarbon is substituted by a hydroxy group. That is, the alcohol includes: an aliphatic hydrocarbon group or an alicyclic hydrocarbon group; and a hydroxy group. The hydrocarbon group is an atomic group remaining after removing one hydrogen atom or two or more hydrogen atoms from a hydrocarbon molecule being a compound consisting only of carbon and hydrogen. The hydrocarbon group may be an alkyl group, an alkenyl group, or an atomic group including a combination of these. The alcohol may be free of a nitrogen atom.

The number of hydroxy groups included in the alcohol is not particularly limited, and may be one or may be two or more. A position of the hydroxy group is not limited to a particular position, and may be a terminal of the hydrocarbon group.

The alcohol may include at least one selected from the group consisting of a chain alkyl group having 10 or more carbon atoms and a chain alkenyl group having 10 or more carbon atoms.

The alcohol may include a chain alkyl group having 10 or more carbon atoms. When a linear alkyl group having 10 or more carbon atoms is included, the dispersibility of the solid electrolyte 101 can be further improved.

The alcohol may include a chain alkenyl group having 10 or more carbon atoms. A position of an unsaturated bond in the alkenyl group is not limited to a particular position, and the number of unsaturated bonds in the alkenyl group is not particularly limited and may be 1 to 3.

In the alcohol, the number of carbon atoms in the chain alkyl group or the chain alkenyl group may be 10 or more and 30 or less, 12 or more and 22 or less, or 14 or more and 20 or less. When the number of carbon atoms is 10 or more, the dispersibility of the solid electrolyte 101 can be improved. When the number of carbon atoms is 30 or less, the solid electrolyte 101 and the electrode active material 201 can exhibit improved filling properties.

The alcohol may include an organic substance derived from a natural oil or fat. The alcohol may be an organic substance derived from a natural oil or fat. In the alcohol, the alkyl group or the alkenyl group may be an alkyl group derived from a natural oil or fat or an alkenyl group derived from a natural oil or fat. Examples of the alkyl group derived from a natural oil or fat or the alkenyl group derived from a natural oil or fat are as described above.

Examples of the alcohol include 1-hexadecanol, stearylalcohol, cetearyl alcohol, isostearyl alcohol, oleyl alcohol, linoleyl alcohol, arachidyl alcohol, behenyl alcohol, hydrogenated rapeseed alcohol, 2-decyltetradecanol, 2-(4-octylphenyl) ethanol, pentadecanediol, octadecanediol, and 2-octyl-1-dodecanol.

The alcohol may include oleyl alcohol. The alcohol may be oleyl alcohol. Oleyl alcohol is liquid at ordinary temperature. Additionally, oleyl alcohol is an alcohol including a long-chain alkenyl group. When the alcohol includes oleyl alcohol, the dispersibility of the solid electrolyte 101 can be further improved. Moreover, when the alcohol includes oleyl alcohol, the solid electrolyte 101 and the electrode active material 201 can exhibit further improved filling properties at the time of pressure molding.

The alcohol may include isostearyl alcohol. The alcohol may be isostearyl alcohol. Isostearyl alcohol is liquid at ordinary temperature. Additionally, isostearyl alcohol is a long-chain alkylalcohol including a methyl branched chain. When the alcohol includes isostearyl alcohol, the dispersibility of the solid electrolyte 101 can be further improved. Moreover, when the alcohol includes isostearyl alcohol, the solid electrolyte 101 and the electrode active material 201 can exhibit further improved filling properties at the time of pressure molding.

As described above, in the electrode composition 1000, the dispersant 104 includes the first dispersant 104a and the second dispersant 104b. The first dispersant 104a includes at least one selected from the group consisting of the phenols and the amino hydroxy compound. The second dispersant 104b includes at least one selected from the group consisting of the nitrogen-containing compound and the alcohol. The second dispersant 104b is a dispersant, for example, of a different type from the first dispersant 104a. The chemical composition of the second dispersant 104b is, for example, different from that of the first dispersant 104a. That is, the nitrogen-containing compound has a chemical composition other than those of the phenols and the amino hydroxy compound. The alcohol has a chemical composition other than those of the phenols and the amino hydroxy compound.

### <Solvent>

The solvent 102 may be an organic solvent. The organic solvent is a carbon-containing compound, and is, for example, a compound containing an element such as carbon, hydrogen, nitrogen, oxygen, sulfur, or a halogen.

The solvent 102 may include at least one selected from the group consisting of a hydrocarbon, a halogen-group-containing compound, and a compound having an ether bond.

The hydrocarbon is a compound consisting of carbon and hydrogen. The hydrocarbon may be an aliphatic hydrocarbon. The hydrocarbon may be a saturated hydrocarbon or an unsaturated hydrocarbon. The hydrocarbon may be linear or branched. The number of carbon atoms included in the hydrocarbon is not particularly limited, and may be 7 or more. The electrode composition 1000 in which the solid electrolyte 101 and the electrode active material 201 are dispersed well can be obtained by using the hydrocarbon. Furthermore, a decrease of the ionic conductivity of the solid electrolyte 101 can be reduced, the decrease being caused by mixing the solid electrolyte 101 with the solvent 102.

The hydrocarbon may have a ring structure. The ring structure may be an alicyclic hydrocarbon or an aromatic hydrocarbon. The ring structure may be monocyclic or polycyclic. When the hydrocarbon has the ring structure, the solid electrolyte 101 and the electrode active material 201 can be easily dispersed in the solvent 102. The hydrocarbon may include an aromatic hydrocarbon to increase the dispersibilities of the solid electrolyte 101 and the electrode active material 201 in the electrode composition 1000. That is, the solvent 102 may include an aromatic hydrocarbon. The hydrocarbon may be an aromatic hydrocarbon. Styrene elastomers are highly soluble in aromatic hydrocarbons. Because of this, when the binder 103 includes the styrene elastomer and the solvent 102 includes an aromatic hydrocarbon, the binder 103 can be more efficiently adsorbed to the solid electrolyte 101 in the electrode composition 1000. This can further enhance a solvent retention performance of the electrode composition 1000.

A portion of the halogen-group-containing compound may be composed of carbon and hydrogen, the portion excluding the halogen group. That is, the halogen-group-containing compound means a compound in which at least one hydrogen atom included in a hydrocarbon is substituted by a halogen group. Examples of the halogen group include F, Cl, Br, and I. At least one selected from the group consisting of F, Cl, Br, and I may be used as the halogen group. The halogen-group-containing compound can have high polarity. Since the solid electrolyte 101 and the electrode active material 201 can be easily dispersed in the solvent 102 including the halogen-group-containing compound, the electrode composition 1000 in which the solid electrolyte 101 and the electrode active material 201 are dispersed well can be obtained. Consequently, an electrode sheet manufactured using the electrode composition 1000 can have excellent ionic conductivity and a denser structure.

The number of carbon atoms included in the halogen-group-containing compound is not particularly limited, and may be 7 or more. The halogen-group-containing compound does not easily volatilize in this case, and thus the electrode composition 1000 can be stably manufactured. The halogen-group-containing compound can have a large molecular weight. That is, the halogen-group-containing compound can have a high boiling point.

The halogen-group-containing compound may have a ring structure. The ring structure may be an alicyclic hydrocarbon or an aromatic hydrocarbon. The ring structure may be monocyclic or polycyclic. When the halogen-group-containing compound has the ring structure, the solid electrolyte 101 and the electrode active material 201 can be easily dispersed in the solvent 102. The halogen-group-containing compound may include an aromatic hydrocarbon to increase the dispersibilities of the solid electrolyte 101 and the electrode active material 201 in the electrode composition 1000. The halogen-group-containing compound may be an aromatic hydrocarbon.

The halogen-group-containing compound may include a halogen group only as a functional group thereof. In this case, the number of halogen atoms included in the halogen-group-containing compound is not particularly limited. At least one selected from the group consisting of F, Cl, Br, and I may be used as the halogen group. Since the solid electrolyte 101 and the electrode active material 201 can be easily dispersed in the solvent 102 including such a compound, the electrode composition 1000 in which the solid electrolyte 101 and the electrode active material 201 are dispersed well can be obtained. Consequently, an electrode sheet manufactured using the electrode composition 1000 can have excellent ionic conductivity and a denser structure. Such a compound included in the solvent 102 can make it easy for an electrode sheet manufactured using the electrode composition 1000 to have a dense structure including only a small number of pinholes, asperities, etc.

The halogen-group-containing compound may be a halogenated hydrocarbon. The halogenated hydrocarbon means a compound in which every hydrogen atom included in a hydrocarbon is substituted by a halogen group. Since the solid electrolyte 101 and the electrode active material 201 can be easily dispersed in the solvent 102 including the halogenated hydrocarbon, the electrode composition 1000 in which the solid electrolyte 101 and the electrode active material 201 are dispersed well can be obtained. Consequently, an electrode sheet manufactured using the electrode composition 1000 can have excellent ionic conductivity and a denser structure. Such a compound included in the solvent 102 can make it easy for an electrode sheet manufactured using the electrode composition 1000 to have a dense structure including only a small number of pinholes, asperities, etc.

A portion of the compound having an ether bond may be composed of carbon and hydrogen, the portion excluding the ether bond. That is, the compound having an ether bond means a compound in which at least one C—C bond included in a hydrocarbon is substituted by a C—O—C bond. The compound having an ether bond can have high polarity. The solid electrolyte 101 and the electrode active material 201 can be easily dispersed in the solvent 102 including the compound having an ether bond. Hence, the electrode composition 1000 in which the solid electrolyte 101 and the electrode active material 201 are dispersed well can be obtained. Consequently, an electrode sheet manufactured using the electrode composition 1000 can have excellent ionic conductivity and a denser structure.

The compound having an ether bond may have a ring structure. The ring structure may be an alicyclic hydrocarbon or an aromatic hydrocarbon. The ring structure may be monocyclic or polycyclic. When the compound having an ether bond has the ring structure, the solid electrolyte 101 and the electrode active material 201 can be easily dispersed in the solvent 102. The compound having an ether bond may include an aromatic hydrocarbon to increase the dispersibilities of the solid electrolyte 101 and the electrode active material 201 in the electrode composition 1000. The compound having an ether bond may be a compound formed by introducing an ether group to an aromatic hydrocarbon by substitution.

Examples of the solvent 102 include ethylbenzene, mesitylene, pseudocumene, p-xylene, cumene, tetralin, m-xylene, dibutyl ether, 1,2,4-trichlorobenzene, chlorobenzene, 2,4-dichlorotoluene, anisole, o-chlorotoluene, m-dichlorobenzene, p-chlorotoluene, o-dichlorobenzene, 1,4-dichlorobutane, and 3,4-dichlorotoluene. One of these may be used alone, or two or more of these may be used in combination.

A commercially-available xylene, namely a xylene mixture, may be used as the solvent 102 from a cost standpoint. For example, a xylene mixture in which o-xylene, m-xylene, p-xylene, and ethylbenzene are mixed at a mass ratio of 24:42:18:16 may be used as the solvent 102.

The solvent 102 may include tetralin. Tetralin has a relatively high boiling point. Tetralin not only enhance the solvent retention performance of the electrode composition 1000, but makes it possible to stably manufacture the electrode composition 1000 by a kneading process.

The solvent 102 may have a boiling point of 100° C. or higher and 250° C. or lower, 130° C. or higher and 230° C. or lower, 150° C. or higher and 220° C. or lower, or 180° C. or higher and 210° C. or lower. The solvent 102 may be liquid at ordinary temperature (25° C.). Such a solvent does not easily volatilize at ordinary temperature, and thus the electrode composition 1000 can be stably manufactured. Therefore, the electrode composition 1000 that can be easily applied to a surface of an electrode or a substrate can be obtained. The solvent 102 included in the electrode composition 1000 can be easily removed by drying as later described.

The amount of moisture in the solvent 102 may be 10 mass ppm or less. A decrease of the ionic conductivity due to a reaction of the solid electrolyte 101 can be reduced by decreasing the amount of moisture. Examples of the method for decreasing the amount of moisture include a dehydration method using a molecular sieve and a dehydration method by bubbling using an inert gas such as nitrogen gas or argon gas. The dehydration method by bubbling using an inert gas is recommended because, by that method, deoxygenation can be achieved simultaneously with dehydration. The amount of moisture can be measured with a Karl Fischer moisture meter.

The solvent 102 allows the solid electrolyte 101 and the electrode active material 201 to be dispersed therein. The solvent 102 can be a liquid in which the solid electrolyte 101 can be dispersed. The solid electrolyte 101 may be undissolved in the solvent 102. The solid electrolyte 101 not dissolved in the solvent 102 makes it likely that an ion conducting phase of the solid electrolyte 101 having just been manufactured be maintained. Hence, an electrode sheet manufactured using this electrode composition 1000 can reduce a decrease of the ionic conductivity.

The solvent 102 may dissolve the solid electrolyte 101 partly or wholly. The density of an electrode sheet manufactured using the electrode composition 1000 can be improved by dissolving the solid electrolyte 101.

### <Electrode Active Material>

The electrode active material 201 includes a material having properties of occluding and releasing metal ions (e.g., lithium ions). The electrode active material 201 includes, for example, a positive electrode active material or a negative electrode active material. When the electrode composition 1000 includes the electrode active material 201, a lithium secondary battery can be manufactured using an electrode sheet made from the electrode composition 1000.

The electrode active material 201 includes a positive electrode active material. The positive electrode active material includes, for example, an oxide. The electrode active material 201 includes, for example, a material having properties of occluding and releasing metal ions (e.g., lithium ions) as a positive electrode active material. Examples of the positive electrode active material include a lithium-containing transition metal oxide, a lithium-containing transition metal phosphate, a transition metal fluoride, a polyanion material, a fluorinated polyanion material, a transition metal sulfide, a transition metal oxysulfide, and a transition metal oxynitride. Examples of the lithium-containing transition metal oxide include Li(NiCoAl)O₂, Li(NiCoMn)O₂, and LiCoO₂. When the lithium-containing transition metal oxide, for example, is used as the positive electrode active material, the manufacturing cost of the electrode composition 1000 can be reduced and an average discharge voltage of a battery can be improved. Li(NiCoAl)O₂ means that Ni, Co, and Al are included in any proportion. Li(NiCoMn)O₂ means that Ni, Co, and Mn are included in any proportion.

The positive electrode active material may have a median diameter of 0.1 μm or more and 100 μm or less, or 1 μm or more and 10 μm or less. When the positive electrode active material has a median diameter of 0.1 μm or more, the electrode active material 201 can be easily dispersed in the solvent 102 in the electrode composition 1000. This improves charge and discharge characteristics of a battery including an electrode sheet manufactured using the electrode composition 1000. When the positive electrode active material has a median diameter of 100 μm or less, a diffusion rate of lithium in the positive electrode active material is improved. This allows a battery to operate at high power.

The electrode active material 201 includes a negative electrode active material. The negative electrode active material includes, for example, an oxide. The electrode active material 201 includes, for example, a material having properties of occluding and releasing metal ions (e.g., lithium ions) as a negative electrode active material. Examples of the negative electrode active material include a metal material, a carbon material, an oxide, a nitride, a tin compound, and a silicon compound. The metal material may be an elemental metal or an alloy. Examples of the metal material include lithium metal and a lithium alloy. Examples of the carbon material include natural graphite, coke, semi-graphitized carbon, carbon fibers, spherical carbon, artificial graphite, and amorphous carbon. A capacity density of a battery can be improved by using silicon (Si), tin (Sn), a silicon compound, a tin compound, or the like. The safety of a battery can be improved by using an oxide including titanium (Ti) or niobium (Nb).

The negative electrode active material may have a median diameter of 0.1 μm or more and 100 μm or less, or 1 μm or more and 10 μm or less. When the negative electrode active material has a median diameter of 0.1 μm or more, the electrode active material 201 can be easily dispersed in the solvent 102 in the electrode composition 1000. This improves charge and discharge characteristics of a battery including an electrode sheet manufactured using the electrode composition 1000. When the negative electrode active material has a median diameter of 100 μm or less, a diffusion rate of lithium in the negative electrode active material is improved. This allows a battery to operate at high power.

The positive electrode active material and the negative electrode active material each may be coated with a coating material so as to decrease an interfacial resistance between the active material and the solid electrolyte. That is, a coating layer may be provided on a surface of each the positive electrode active material and the negative electrode active material. The coating layer may be a layer including the coating material. A low-electron-conductive material can be used as the coating material. An oxide material, an oxide solid electrolyte, a halide solid electrolyte, a sulfide solid electrolyte, or the like can be used as the coating material. The positive electrode active material and the negative electrode active material may be coated with only one coating material selected from the above materials. That is, the coating layer may be formed of only one coating material selected from the above materials. Alternatively, the coating layer may be composed of two or more layers and include two or more coating materials selected from the above materials.

Examples of the oxide material used as the coating material include SiO₂, Al₂O₃, TiO₂, B₂O₃, Nb₂O₅, WO₃, and ZrO₂.

The oxide solid electrolytes shown as examples in Embodiment 1 may be used as the oxide solid electrolyte used as the coating material. Examples of the oxide solid electrolyte used as the coating material include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄Ti₅O₁₂, Li—Zr—O compounds such as Li₂ZrO₃, Li—Mo—O compounds such as Li₂MoO₃, Li—V—O compounds such as LiV₂O₅, Li—W—O compounds such as Li₂WO₄, and Li—P—O compounds such as LiPO₄. The oxide solid electrolyte has a high-potential stability. The cycle performance of a battery can therefore further be improved by using the oxide solid electrolyte as the coating material.

The halide solid electrolyte shown as examples in Embodiment 1 may be used as the halide solid electrolyte used as the coating material. Examples of the halide solid electrolyte used as the coating material include Li—Y—Cl compounds such as LiYCl₆, Li—Y—Br—Cl compounds such as LiYBr₂Cl₄, Li—Ta—O—Cl compounds such as LiTaOCl₄, and Li—Ti—Al—F compounds such as Li_{2.7}Ti_{0.3}Al_{0.7}F₆. The halide solid electrolyte has a high ionic conductivity and a high potential stability. The cycle performance of a battery can therefore further be improved by using the halide solid electrolyte as the coating material.

The sulfide solid electrolyte shown as examples in Embodiment 1 may be used as the sulfide solid electrolyte used as the coating material. Examples of the sulfide solid electrolyte used as the coating material include Li—P—S compounds such as Li₂S—P₂S₅. The sulfide solid electrolyte has a high ionic conductivity and a low Young's modulus. The sulfide solid electrolyte used as the coating material can therefore be formed into a uniform coating and can further improve the cycle performance of a battery.

### <Electrode Composition>

Each material of the electrode composition 1000 is, for example, particulate. In the electrode composition 1000, the particles of the materials are mixed with the solvent 102. In manufacture of the electrode composition 1000, the method for mixing the electrode active material 201, the solid electrolyte 101, the solvent 102, the binder 103, the first dispersant 104a, and the second dispersant 104b is not limited to a particular method. One example of the mixing method is a mixing method in which a stirring mixer, a shaker mixer, an ultrasonic mixer, a rotating mixer, or the like is used. Another example of the mixing method is a mixing method in which a dispersion kneader such as a high-speed homogenizer, a thin-film spin high-speed mixer, an ultrasonic homogenizer, a high-pressure homogenizer, a ball mill, a bead mill, a planetary mixer, a sand mill, a roll mill, or a kneader is used. One of these mixing methods may be used alone, or two or more of these mixing methods may be used in combination.

### [Electrode Composition Manufacturing Method]

The electrode composition 1000 is manufactured, for example, by the following method. First, the electrode active material 201 and the solvent 102 are mixed, and a dispersant solution is added to the resulting mixture to prepare a liquid mixture. The liquid mixture obtained is subjected to high-speed shearing using an inline dispersion grinder to prepare a dispersion. Next, a binder solution and the solid electrolyte 101 are added to the dispersion to prepare a liquid mixture. The liquid mixture obtained is subjected to high-speed shearing using an inline dispersion grinder to prepare a dispersion. Through these steps, the electrode composition 1000 including the electrode active material 201 and the solid electrolyte 101 and having higher fluidity can be manufactured.

The electrode composition 1000 may be manufactured, for example, by the following method. First, the electrode active material 201 and the solvent 102 are mixed, and a dispersant solution is added to the resulting mixture to prepare a liquid mixture. The liquid mixture obtained is subjected to high-speed shearing using an ultrasonic homogenizer to prepare a dispersion. Next, a binder solution and the solid electrolyte 101 are added to the dispersion to prepare a liquid mixture. The liquid mixture obtained is subjected to high-speed shearing using an ultrasonic homogenizer. Through these steps, the electrode composition 1000 including the electrode active material 201 and the solid electrolyte 101 and having higher fluidity can be manufactured.

To manufacture the electrode composition 1000 having high fluidity, high-speed shearing or ultrasonic high-speed shearing may be performed under a condition where grinding of the particles of the solid electrolyte 101 and the particles of the electrode active material 201 does not occur and disintegration of the particles of the solid electrolyte 101 and disintegration of the particles of the electrode active material 201 occur.

The electrode composition 1000 may be manufactured by the following method. A first liquid mixture containing the electrode active material 201, the first dispersant 104a, and a first solvent is prepared. A second liquid mixture containing the solid electrolyte 101, the second dispersant 104b, and a second solvent is prepared. The first liquid mixture and the second liquid mixture are mixed to prepare an electrode slurry. In the case of manufacturing the electrode composition 1000 in this order, the dispersibility of the electrode active material 201 and that of the solid electrolyte 101 can be improved. The first solvent and the second solvent may be the same solvent or may be different solvents. As a matter of course, the electrode active material 201, the solid electrolyte 101, the first dispersant 104a, the second dispersant 104b, and the solvent may be mixed together at once to prepare an electrode slurry.

The electrode composition 1000 may include the conductive additive 106 to improve the electron conductivity. Examples of the conductive additive 106 include: graphites such as natural graphite and artificial graphite; carbon blacks such as acetylene black and ketjen black; conductive fibers such as a carbon fiber and a metal fiber; conductive powders such as a fluorinated carbon powder and an aluminum powder; conductive whiskers such as a zinc oxide whisker and a potassium titanate whisker; conductive metal oxides such as titanium oxide; and conductive polymers such as polyaniline, polypyrrole, and polythiophene. Using the carbon material as the conductive additive 106 can seek cost reduction.

A solids concentration in the electrode composition 1000 is determined as appropriate according to the particle diameter of the electrode active material 201, the specific surface area of the electrode active material 201, the particle diameter of the solid electrolyte 101, the specific surface area of the solid electrolyte 101, the type of solvent 102, the type of binder 103, the type of first dispersant 104a, and the type of second dispersant 104b. The solids concentration in the electrode composition 1000 may be 40 mass % or more and 90 mass % or less, or 50 mass % or more and 80 mass % or less. When the solids concentration is 40 mass % or more, a viscosity of the electrode composition 1000 is so high that a trickle of the electrode composition 1000 applied to a substrate such as an electrode can be reduced. When the solids concentration is 90 mass % or less, a wet film thickness of the electrode composition 1000 applied to a substrate can be relatively increased and thus an electrode sheet having a more uniform thickness can be manufactured.

### Embodiment 2

Embodiment 2 will be described hereinafter. The description overlapping that in Embodiment 1 will be omitted as appropriate.

An electrode sheet of Embodiment 2 is manufactured using the electrode composition 1000 of Embodiment 1. A method for manufacturing the electrode sheet of Embodiment 2 includes: applying the electrode composition 1000 to a current collector, a substrate, or an electrode assembly to form a coating film; and removing the solvent from the coating film.

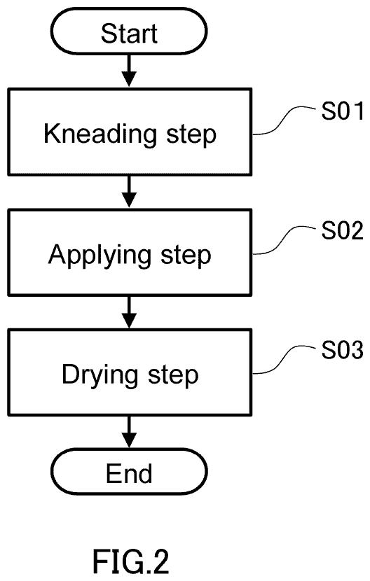

The electrode sheet manufacturing method will be described hereinafter with reference to FIG. 2. FIG. 2 is a flow chart showing the electrode sheet manufacturing method.

The electrode sheet manufacturing method may include steps S01, S02, and S03. The step S01 in FIG. 2 corresponds to the method described in Embodiment 1 for manufacturing the electrode composition 1000. The electrode sheet manufacturing method includes: the step S02 of applying the electrode composition 1000 of Embodiment 1; and the step S03 of drying the applied electrode composition 1000. The steps S01, S02, and S03 may be performed in this order. As described above, the electrode sheet is obtained by applying and drying the electrode composition 1000. In other words, the electrode sheet is a solid of the electrode composition 1000.

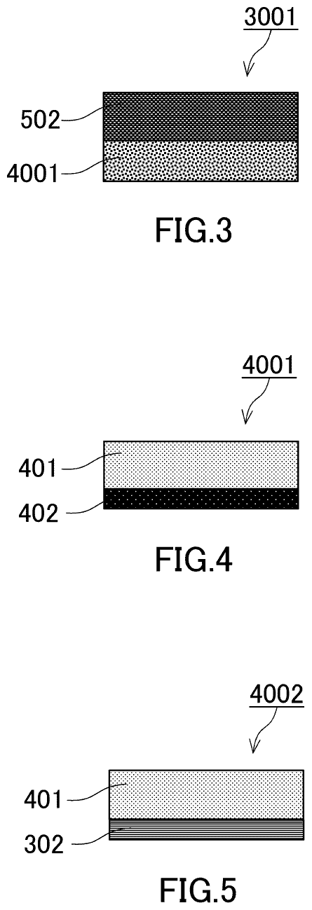

FIG. 3 is a cross-sectional view showing an electrode assembly 3001 of Embodiment 2. The electrode assembly 3001 includes an electrode 4001 and an electrolyte layer 502 disposed on the electrode 4001.

FIG. 4 is a cross-sectional view showing the electrode 4001 of Embodiment 2. The electrode 4001 includes a current collector 402 and an electrode sheet 401 disposed on the current collector 402. The electrode 4001 can be manufactured by the method including, as the step S02, a step of applying the electrode composition 1000 to the current collector 402.

FIG. 5 is a cross-sectional view showing an electrode transfer sheet 4002 of Embodiment 2. The electrode transfer sheet 4002 includes a substrate 302 and the electrode sheet 401 disposed on the substrate 302. The electrode transfer sheet 4002 being a layered body composed of the substrate 302 and the electrode sheet 401 can be manufactured by the method including, as the step S02, a step of applying the electrode composition 1000 to the substrate 302.

Examples of the material of the substrate 302 include a metallic foil and a resin film. Examples of the material of the metallic foil include copper (Cu), aluminum (Al), iron (Fe), nickel (Ni), and their alloys. Examples of the material of the resin film include polyethylene terephthalate (PET), polyimide (PI), and polytetrafluoroethylene (PTFE). The electrode transfer sheet 4002 being a layered body composed of the substrate 302 and the electrode sheet 401 is manufactured by applying the electrode composition 1000 to the substrate 302 and performing the step S03 described below.

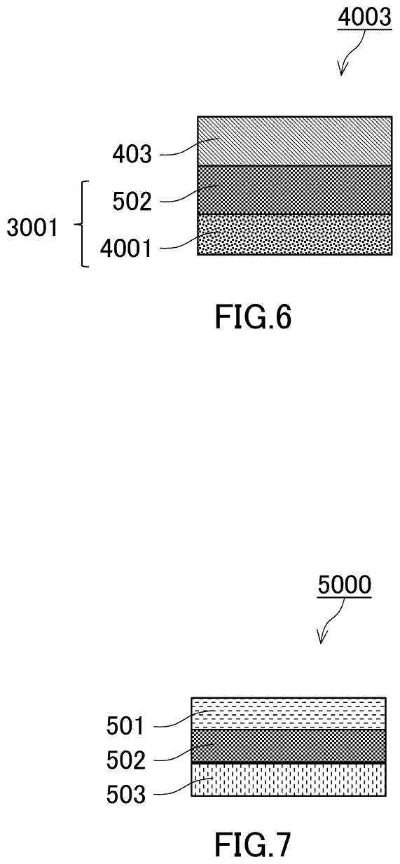

FIG. 6 is a cross-sectional view showing a battery precursor 4003 of Embodiment 2. The battery precursor 4003 includes the electrode 4001, the electrolyte layer 502, and an electrode sheet 403. The electrolyte layer 502 is disposed on the electrode 4001. Additionally, the electrode sheet 403 is disposed on the electrolyte layer 502. The electrode 4001 includes the current collector 402 and the electrode sheet 401 disposed on the current collector 402. The electrode assembly 3001 includes the electrode 4001 and the electrolyte layer 502 disposed on the electrode 4001. The battery precursor 4003 can be manufacture by the method including, as the step S02, a step of applying the electrode composition 1000 to the electrode assembly 3001 being a layered body composed of the electrode 4001 and the electrolyte layer 502.

In the step S02, the electrode composition 1000 is applied to the current collector 402, the substrate 302, or the electrode assembly 3001. A coating film made of the electrode composition 1000 is thereby formed on the current collector 402, the substrate 302, or the electrode assembly 3001.

Examples of the application technique include die coating, gravure coating, doctor blade coating, bar coating, spray coating, and electrostatic coating. Die coating may be adopted from the mass productivity standpoint.

Examples of the material of the current collector 402 include a metallic foil. Examples of the material of the metallic foil include copper (Cu), aluminum (Al), iron (Fe), nickel (Ni), and their alloys. A coating layer composed of the above conductive additive and the above binder may be placed on a surface of the metallic foil. The electrode 4001 being a layered body composed of the current collector 402 and the electrode sheet 401 is manufactured by applying the electrode composition 1000 to the current collector 402 and performing the step S03 described below.

Next, the electrolyte layer 502 is formed on the electrode 4001. The method for forming the electrolyte layer 502 is not limited to a particular method.

After that, the electrode sheet 403 is formed on the electrolyte layer 502. The method for forming the electrode sheet 403 is, for example, the same as the method for forming the electrode sheet 401. That is, the electrode sheet 403 is formed on the electrolyte layer 502 by applying the electrode composition 1000 to the electrolyte layer 502 and performing the step S03.

The electrode composition 1000 applied is dried in the step S03. For example, the solvent 102 is removed from the coating film made of the electrode composition 1000 by drying the electrode composition 1000, and thus the electrode sheet 403 is manufactured.

Examples of the drying method for removing the solvent 102 from the electrode composition 1000 include warm-air/hot-air drying, infrared drying, reduced-pressure drying, vacuum drying, high-frequency dielectric heating drying, and high-frequency induction heating drying. One of these may be used alone, or two or more of these may be used in combination.

The solvent 102 may be removed from the electrode composition 1000 by reduced-pressure drying. That is, the solvent 102 may be removed from the electrode composition 1000 in an atmosphere at a pressure lower than an atmospheric pressure. The atmosphere at a pressure lower than an atmospheric pressure may be, for example, −0.01 MPa or lower in gauge pressure. The reduced-pressure drying may be performed at 50° C. or higher and 250° C. or lower.

The solvent 102 may be removed from the electrode composition 1000 by vacuum drying. That is, the solvent 102 may be removed from the electrode composition 1000 at a temperature lower than the boiling point of the solvent 102 in an atmosphere at a pressure equal to or lower than an equilibrium vapor pressure of the solvent 102.

The solvent 102 may be removed from the electrode composition 1000 by warm-air/hot-air drying from a manufacturing cost standpoint. A setting temperature of warm air/hot air may be 50° C. or higher and 250° C. or lower, or 80° C. or higher and 150° C. or lower.

In the step S03, part or all of the first dispersant 104a may be removed in conjunction with the removal of the solvent 102. In the step S03, part or all of the second dispersant 104b may be removed in conjunction with the removal of the solvent 102. Removing the first dispersant 104a and the second dispersant 104b can improve the ionic conductivity of the electrode sheet 401 and the strength of the coating film.

In the step S03, the first dispersant 104a does not necessarily need to be removed in conjunction with the removal of the solvent 102. In the step S03, the second dispersant 104b does not necessarily need to be removed in conjunction with the removal of the solvent 102. The first dispersant 104a and the second dispersant 104b each play a lubricant-oil-like role at the time of pressure molding in battery manufacturing. Hence, the filling properties of the solid electrolyte 101 and the electrode active material 201.

In the step S03, amounts of the solvent 102, the first dispersant 104a, and the second dispersant 104b removed from the electrode composition 1000 can be adjusted by the above-described drying method and drying conditions can be improved.

Removal of the solvent 102, the first dispersant 104a, and the second dispersant 104b can be confirmed, for example, by Fourier-transform infrared spectroscopy (FT-IR), X-ray photoelectron spectroscopy (XPS), gas chromatography (GC), or gas chromatography-mass spectrometry (GC-MS). Note that the dried electrode sheet 401 is required to have ion conductivity and that complete removal of the solvent 102 is not required. Part of the solvent 102 may be left in the electrode sheet 401.

The battery precursor 4003 can be manufactured, for example, by combining the electrode 4001 and the electrode sheet 403 having a polarity opposite to that of the electrode 4001. That is, the active material included in the electrode sheet 401 is different from the active material included in the electrode sheet 403. Specifically, when the active material included in the electrode sheet 401 is a positive electrode active material, the active material included in the electrode sheet 403 is a negative electrode active material. When the active material included in the electrode sheet 401 is a negative electrode active material, the active material included in the electrode sheet 403 is a positive electrode active material.

### Embodiment 3

Embodiment 3 will be hereinafter described. The description overlapping those in Embodiments 1 and 2 is omitted as appropriate.

FIG. 7 is a cross-sectional view showing a battery 5000 of Embodiment 3.

The battery 5000 of Embodiment 3 includes a positive electrode 501, a negative electrode 503, and the electrolyte layer 502.

The electrolyte layer 502 is disposed between the positive electrode 501 and the negative electrode 503.

Either the positive electrode 501 or the negative electrode 503 may include the electrode sheet 401 of Embodiment 2.

The method for manufacturing the battery 5000 is not limited to a particular one. The battery 5000 may be manufactured by the following method. A negative electrode in which an electrode sheet (a first negative electrode sheet) is placed on a current collector, a first electrolyte layer, and a first positive electrode are disposed in this order. An electrode sheet (a second negative electrode sheet), a second electrolyte layer, and a second positive electrode are disposed in this order on one surface of the current collector, the one surface facing the other surface with the first negative electrode sheet. A layered body in which the first positive electrode, the first electrolyte layer, the first negative electrode sheet, the current collector, the second negative electrode sheet, the second electrolyte layer, and the second positive electrode are disposed in this order can be obtained in this manner. The battery 5000 may be manufactured by pressure-molding this layered body using a press machine at ordinary temperature or high temperature. By this method, a layered body of two batteries 5000 for which warpage is suppressed can be produced, and the battery 5000 that operates at high power can be manufactured more efficiently. In production of the layered body, the order in which the members are stacked is not particularly limited. For example, the layered body of two batteries 5000 may be produced by disposing the first negative electrode sheet and the second negative electrode sheet on the current collector and then placing the first electrolyte layer, the second electrolyte layer, the first positive electrode, and the second positive electrode in this order.

The shape of the battery 5000 is, for example, a coin type, a cylindrical type, a prismatic type, a sheet type, a button type, a flat type, or a layer-built type.

### EXAMPLES

Hereinafter, the details of the present disclosure will be described with reference to examples and comparative examples. The electrode sheet and the battery of the present disclosure are not limited to the following examples.

### 1. Evaluation of Active Material Slurry

### Sample 1-1

### [Production of Active Material Slurry]

An electrode active material, a dispersant, and a solvent were mixed, and an ultrasonic homogenizer was used for one minute to produce an active material slurry according to Sample 1-1. Lithium titanate Li₄Ti₅O₁₂ (hereinafter referred to as “LTO”) having an average particle diameter of 1 μm was used as the electrode active material. 4-Dodecylphenol was used as the dispersant. Tetralin was used as the solvent. The active material slurry was produced by mixing these materials at a mass ratio of LTO to the additive=100:0.2.

### [Evaluation of Viscosity of Active Material Slurry]

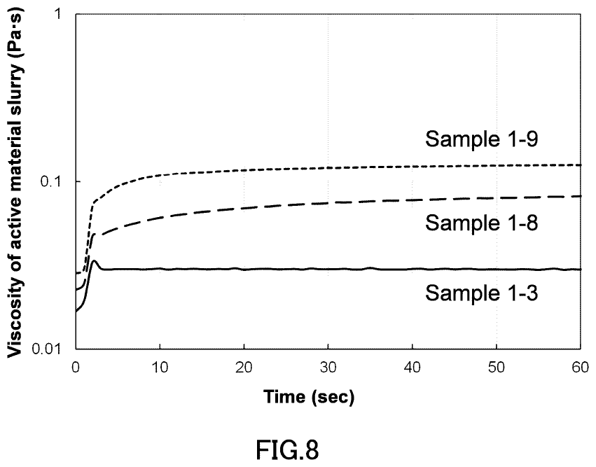

A viscosity of the active material slurry was evaluated by the following method. First, the viscosity of the active material slurry was measured using a rheometer at varying shear rates. The shear rate of the rheometer was changed from 0.1 (1/sec) to 1 (1/sec), 10 (1/sec), 100 (1/sec), 1000 (1/sec), and 2000 (1/sec). The viscosity of the active material slurry was measured for 60 minutes at each shear rate. After that, the shear rate was set at 100 (1/sec) again, and the viscosity of the active material slurry was measured for 60 minutes at this shear rate. FIG. 8 shows the result. FIG. 8 is a graph showing the result of measuring the viscosity of the active material slurry at a shear rate of 100 (1/sec). In FIG. 8, the vertical axis indicates the viscosity of the active material slurry. The horizontal axis indicates the time since the shear rate was set at 100 (1/sec) again.

Next, in FIG. 8, a viscosity of the active material slurry three seconds after the start of the measurement was defined as A. In FIG. 8, a viscosity of the active material slurry 13 seconds after the start of the measurement was defined as B. When a ratio B/A of the viscosity B to the viscosity A was 0.9 or more and 1.1 or less, it was concluded that the viscosity of the active material slurry had not changed. Table 1 shows the results. In Table 1, a circle (∘) indicates that the viscosity of the active material slurry did not change in the above measurement. An ex (x) indicates that the viscosity of the active material slurry gradually increased in the above measurement.

### [Measurement of Arithmetic Surface Roughness of Active Material Sheet]

The active material slurry was applied to a glass substrate using an applicator with a 100 μm gap to form a coating film. The coating film was dried at 100° C. for 15 minutes to produce an active material sheet. An arithmetic surface roughness Sa of a surface of the active material sheet was measured. The measurement was performed in an argon glove box having a dew point of −60° C. or lower. The measurement of the arithmetic surface roughness Sa was performed using a shape measurement laser microscope VK—X1000 manufactured by Keyence Corporation. The surface of the active material sheet was observed using a 50× objective to obtain an image. This image was analyzed to determine the arithmetic average roughness Sa of the surface of the active material sheet. Table 1 shows the result. In Table 1, a circle (o) indicates that Sa was less than 0.6 μm. An ex (x) indicates that Sa was 0.6 μm or more.

### Sample 1-2

An active material slurry according to Sample 1-2 was produced in the same manner as for Sample 1-1, except that diethanol laurylamine was used as the dispersant.

### Sample 1-3

An active material slurry according to Sample 1-3 was produced in the same manner as for Sample 1-1, except that 1-hydroxyethyl-2-alkenylimidazoline (DISPERBYK-109 manufactured by BYK) was used as the dispersant. “DISPERBYK” is a registered trademark of BYK.

### Sample 1-4

An active material slurry according to Sample 1-4 was produced in the same manner as for Sample 1-1, except that oleylamine was used as the dispersant.

### Sample 1-5

An active material slurry according to Sample 1-5 was produced in the same manner as for Sample 1-1, except that dimethylpalmitylamine was used as the dispersant.

### Sample 1-6

An active material slurry according to Sample 1-6 was produced in the same manner as for Sample 1-1, except that 2-octyl-1-dodecanol was used as the dispersant.

### Sample 1-7

An active material slurry according to Sample 1-7 was produced in the same manner as for Sample 1-1, except that oleyl alcohol was used as the dispersant.

### Sample 1-8

An active material slurry according to Sample 1-8 was produced in the same manner as for Sample 1-1, except that isostearyl alcohol was used as the dispersant.

### Sample 1-9

An active material slurry according to Sample 1-9 was produced in the same manner as for Sample 1-1, except that 1-hexadecanol was used as the dispersant.

### <Evaluation of Active Material Slurry>

Evaluation of the viscosity of the active material slurry and measurement of the arithmetic surface roughness of the surface of the active material sheet were performed for the active material slurries according to Sample 1-2 to Sample 1-9 by the above methods. Table 1 shows the results.

TABLE 1

| | | Arithmetic | |
|---|---|---|---|
| | | surface | |
| | | roughness | Viscosity of |
| | Dispersant | Sa | slurry |
| Sample 1-1 | 4-Dodecylphenol | ∘ | ∘ |
| Sample 1-2 | Diethanollaurylamine | ∘ | ∘ |
| Sample 1-3 | 1-Hydroxyethyl-2- | ∘ | ∘ |
| | alkenylimidazoline | | |
| Sample 1-4 | Oleylamine | x | x |
| Sample 1-5 | Dimethylpalmitylamine | x | x |
| Sample 1-6 | 2-Octyl-1- | x | x |
| | dodecanol | | |
| Sample 1-7 | Oleyl alcohol | x | x |
| Sample 1-8 | Isostearyl alcohol | x | x |
| Sample 1-9 | 1-Hexadecanol | x | x |

As for Samples 1-1 to 1-3, the viscosity of each slurry did not rise, and thus the slurry showed a favorable fluidity. Moreover, the arithmetic surface roughness Sa of each of the active material sheets according to Samples 1-1 to 1-3 was less than 0.6 μm. As for Sample 1-1, the ratio B/A of the viscosity B to the viscosity A was 1.05. As for Sample 1-3, the ratio B/A was 0.99. As for Sample 1-8, the ratio B/A was 1.33. As for Sample 1-9, the ratio B/A was 1.40.

The results shown in Table 1 indicate that 4-dodecylphenol, diethanol laurylamine, and 1-hydroxyethyl-2-alkenylimidazoline are dispersants suitable for dispersion of the electrode active material. Hence, an electrode slurry is required to include such a dispersant suitable for dispersion of the electrode active material.

4-Dodecylphenol falls under the category of the phenols. Diethanollaurylamine and 1-hydroxyethyl-2-alkenylimidazoline fall under the category of the amino hydroxy compound.

It is inferred that the same results as the results shown in Table 1 will be obtained even when the electrode active material is not lithium titanium oxide (LTO). It is inferred that the effect of each dispersant on lithium-containing inorganic compounds will be the same as the effect thereof on LTO. Specifically, when the electrode active material is an oxide such as lithium nickel cobalt aluminum oxide, the oxide has an oxygen atom and/or a hydroxy group on its surface as does LTO. Therefore, it is inferred that the effect of each dispersant on the oxide is the same as the effect thereof on LTO.

### 2. Evaluation of Solid Electrolyte Slurry

### Sample 2-1

### [Production of Solid Electrolyte Slurry]

Tetralin and a dispersant were added to a Li₂S—P₂S₅-based glass ceramic (hereinafter referred to as “LPS”) to prepare a liquid mixture. These materials were mixed at a mass ratio of LPS to the dispersant of 100:0.25. Next, the liquid mixture obtained was dispersed and kneaded by shear using a homogenizer (HG-200 manufactured by AS ONE Corporation) and a generator (K-20S manufactured by AS ONE Corporation). A solid electrolyte slurry of Sample 2-1 was obtained in this manner.

The solid electrolyte slurry was applied to a glass substrate using an applicator with a 100 μm gap to form a coating film. The coating film was dried at 100° C. for 15 minutes to produce a solid electrolyte sheet. An arithmetic surface roughness Sa of a surface of the solid electrolyte sheet was measured by the above method.

### [Measurement of Ionic Conductivity Retention Rate]

An ionic conductivity retention rate of the solid electrolyte slurry according to Sample 2-1 was measured by the following method.

First, the solid electrolyte slurry was dried in an argon glove box having a dew point of −60° C. or lower. The drying of the solid electrolyte slurry was performed by heating under a vacuum atmosphere at 100° C. for one hour using a heat drying moisture meter (MX-50 manufactured by A&D Company, Ltd.). The drying was performed until a temporal variation of a remaining solvent rate became 0.10%/min or less. The solvent was thereby removed from the solid electrolyte slurry to give a solid. This solid was crushed to give an ion conductor as a measurement specimen. The temporal variation of the remaining solvent rate means a decrease rate of the amount of the solvent included in the solid electrolyte composition per unit time.

Next, 100 mg of the ion conductor or 100 mg of a solid electrolyte was put into an insulating outer cylinder and was pressure-molded at a pressure of 740 MPa. LPS which is a raw material of the solid electrolyte slurry was used as the solid electrolyte. Next, stainless steel pins were disposed on the top and the bottom of the pressure-molded ion conductor or the pressure-molded solid electrolyte. A current collector lead was fixed to each stainless steel pin. Then, the inside of the insulating outer cylinder was blocked from the outside atmosphere by sealing the insulating outer cylinder with an insulating ferrule. Finally, the resulting battery was fastened with four bolts from the top and the bottom, and a contact pressure of 150 MPa was applied to the ion conductor or the solid electrolyte to produce a sample for ionic conductivity measurement. This sample was placed in a constant-temperature chamber at 25° C. The ionic conductivity of each sample was determined for each sample by an electrochemical AC impedance method using a potentiostat/galvanostat (1470E manufactured by Solartron Analytical) and a frequency response analyzer (1255B manufactured by Solartron Analytical). A ratio of the ionic conductivity of the ion conductor to the ionic conductivity of LPS was calculated from the results. The ionic conductivity retention rate was calculated in this manner for the ion conductor included in the solid electrolyte slurry. Table 2 shows the results.

### Sample 2-2

A solid electrolyte slurry according to Sample 2-2 was produced in the same manner as in Sample 2-1, except that dimethylpalmitylamine was used as the dispersant.

### Sample 2-3

A solid electrolyte slurry according to Sample 2-3 was produced in the same manner as in Sample 2-1, except that 2-octyl-1-dodecanol was used as the dispersant.

### Sample 2-4

A solid electrolyte slurry according to Sample 2-4 was produced in the same manner as in Sample 2-1, except that oleyl alcohol was used as the dispersant.

### Sample 2-5

A solid electrolyte slurry according to Sample 2-5 was produced in the same manner as in Sample 2-1, except that isostearyl alcohol was used as the dispersant.

### Sample 2-6

A solid electrolyte slurry according to Sample 2-6 was produced in the same manner as in Sample 2-1, except that 1-hexadecanol was used as the dispersant.

### Sample 2-7

A solid electrolyte slurry according to Sample 2-7 was produced in the same manner as in Sample 2-1, except that the dispersant was not used.

### Sample 2-8

A solid electrolyte slurry according to Sample 2-8 was produced in the same manner as in Sample 2-1, except that 4-dodecylphenol was used as the dispersant.

### Sample 2-9

A solid electrolyte slurry according to Sample 2-9 was produced in the same manner as in Sample 2-1, except that diethanol laurylamine was used as the dispersant.

### Sample 2-10

A solid electrolyte slurry according to Sample 1-10 was produced in the same manner as for Sample 2-1, except that 1-hydroxyethyl-2-alkenylimidazoline (DISPERBYK-109 manufactured by BYK) was used as the dispersant.

### <Evaluation of Solid Electrolyte Slurry>

For each of the solid electrolyte slurries according to Sample 2-2 to Sample 2-10, the arithmetic surface roughness Sa of a surface of the solid electrolyte sheet and the ionic conductivity retention rate of the solid electrolyte slurry were calculated by the above methods. Table 2 shows the results.

TABLE 2

| | | Arithmetic | Ionic |
|---|---|---|---|
| | | surface | conductivity |
| | | roughness | retention rate |
| | Dispersant | Sa | [%] |
| Sample 2-1 | Oleylamine | ∘ | 100 |
| Sample 2-2 | Dimethylpalmitylamine | ∘ | 100 |
| Sample 2-3 | 2-Octyl-1-dodecanol | ∘ | 100 |
| Sample 2-4 | Oleyl alcohol | ∘ | 100 |
| Sample 2-5 | Isostearyl alcohol | ∘ | 94 |
| Sample 2-6 | 1-Hexadecanol | ∘ | 100 |
| Sample 2-7 | N/A | x | 100 |
| Sample 2-8 | 4-Dodecylphenol | ∘ | 82 |
| Sample 2-9 | Diethanollaurylamine | ∘ | 70 |
| Sample 2-10 | 1-Hydroxyethyl-2- | ∘ | 63 |
| | alkenylimidazoline | | |

The solid electrolyte slurry according to Sample 2-7 did not include a dispersant, and a decrease of the ionic conductivity was not observed. However, the arithmetic surface roughness Sa of the solid electrolyte sheet obtained using the solid electrolyte slurry according to Sample 2-7 was 0.6 μm or more. This is thought to be because the solid electrolyte was not dispersed sufficiently in the solid electrolyte slurry according to Sample 2-7.

For Samples 2-8 to 2-10, the arithmetic surface roughness Sa was less than 0.6 μm. However, for Samples 2-8 to 2-10, the ionic conductivity retention rate was less than 90%. This means that the dispersants used for Samples 2-8 to 2-10 can allow the solid electrolyte to be dispersed but have a large effect on the ionic conductivity. On the other hand, for the solid electrolyte sheets obtained using the solid electrolyte slurries according to Samples 2-1 to 2-6, the arithmetic surface roughness Sa was less than 0.6 μm. Moreover, for the solid electrolyte slurries according to Samples 2-1 to 2-6, the ionic conductivity retention rate was 90% or more.

The results shown in Table 2 indicate that oleylamine, dimethylpalmitylamine, 2-octyl-1-dodecanol, oleyl alcohol, isostearyl alcohol, and 1-hexadecanol are dispersants suitable for dispersion of the solid electrolyte. Hence, the electrode slurry is required to include such a dispersant suitable for dispersion of the solid electrolyte.

Oleylamine and dimethylpalmitylamine fall under the category of the nitrogen-containing compound. 2-Octyl-1-dodecanol, oleyl alcohol, isostearyl alcohol, and 1-hexadecanol fall under the category of the alcohol.

It is inferred that even when the solid electrolyte is not LPS, the same results as the results shown in Table 2 can be obtained. It is inferred that the effect of each dispersant especially on a sulfide solid electrolyte will be the same as the effect thereof on LPS.

As shown in Table 1, when at least one selected from the group consisting of the phenols and the amino hydroxy compound was included in the slurry, the dispersibility of the electrode active material was enhanced, the surface smoothness was improved, and a more uniform electrode sheet was obtained. Moreover, as shown in Table 2, when at least one selected from the group consisting of the nitrogen-containing compound and the alcohol was included in the slurry, the dispersibility of the solid electrolyte was enhanced and a sheet for which a decrease of the ionic conductivity was reduced was obtained. According to Table 1 and Table 2, the electrode composition is required to include both the dispersant suitable for dispersion of the electrode active material and a dispersant suitable for dispersion of the solid electrolyte.

### 3. Evaluation of Battery

### Example 3-1

### [Production of Negative Electrode Composition]

LTO, a conductive additive (VGCF-H manufactured by SHOWA DENKO K.K.), tetralin, and a first dispersant were mixed to produce a first liquid mixture. 1-Hydroxyethyl-2-alkenylimidazoline (DISPERBYK-109 manufactured by BYK) was used as the first dispersant. The first liquid mixture was subjected to dispersion treatment using an ultrasonic homogenizer. A slurry according to Example 3-1 was produced in this manner. “VGCF” is a registered trademark of SHOWA DENKO K.K.

Next, the slurry according to Example 3-1, a LiI—LiBr—Li₂S—P₂S₅-based glass ceramic, a second dispersant, and a binder solution were mixed to prepare a second liquid mixture. Dimethylpalmitylamine was prepared as the second dispersant. A solution containing SBR dissolved in tetralin was used as the binder solution. The second liquid mixture was subjected to dispersion treatment using an ultrasonic homogenizer. A negative electrode composition according to Example 3-1 was produced in this manner.

### [Production of Positive Electrode Composition]

LiNbO₃-coated LiNi_{1/3}Co_{1/3}Mn_{1/3}O₂, a conductive additive (VGCF-H manufactured by SHOWA DENKO K.K.), a LiI—LiBr—Li₂S—P₂S₅-based glass ceramic, a binder solution, and butyl butyrate were mixed to produce a liquid mixture. A solution containing PVdF dissolved in butyl butyrate was used as the binder solution. The liquid mixture was subjected to dispersion treatment using an ultrasonic homogenizer. A positive electrode composition according to Example 3-1 was produced in this manner.

### [Production Solid Electrolyte Composition]

A LiI—LiBr—Li₂S—P₂S₅-based glass ceramic, butyl butyrate, and a binder solution were mixed to produce a liquid mixture. A solution containing butadiene rubber (BR) dissolved in heptane was used as the binder solution. The liquid mixture was subjected to dispersion treatment using an ultrasonic homogenizer. A solid electrolyte composition according to Example 3-1 was produced in this manner.

### [Production of Battery]

First, the positive electrode composition according to Example 3-1 was applied to a positive electrode current collector using an applicator by blade coating to form a coating film. An aluminum foil was used as the positive electrode current collector. This coating film was dried for 30 minutes on a hot plate heated at 100° C. A positive electrode including a positive electrode current collector and a positive electrode layer was obtained.

Next, the positive electrode was pressed. The solid electrolyte composition according to Example 3-1 was applied to a surface of the pressed positive electrode layer using an applicator by blade coating to form a coating film. This coating film was dried for 30 minutes on a hot plate heated at 100° C. to produce a layered body. This layered body was roll-pressed to produce a layered body to be on the positive electrode side, the layered body including the positive electrode current collector, the positive electrode layer, and a solid electrolyte layer.

Meanwhile, the negative electrode composition according to Example 3-1 was applied to a negative electrode current collector using an applicator by blade coating to form a coating film. A copper foil was used as the negative electrode current collector. This coating film was dried for 30 minutes on a hot plate heated at 100° C. A negative electrode including the negative electrode current collector and a negative electrode layer was obtained in this manner.

Next, the negative electrode was pressed. The solid electrolyte composition according to Example 3-1 was applied to a surface of the pressed negative electrode layer using an applicator by blade coating to form a coating film. This coating film was dried for 30 minutes on a hot plate heated at 100° C. to produce a layered body. This layered body was roll-pressed to produce a layered body to be on the negative electrode side, the layered body including the negative electrode current collector, the negative electrode layer, and the solid electrolyte layer.

The layered body to be on the positive electrode side and the layered body to be on the negative electrode side were each subjected to punching processing. Then, the layered bodies were disposed such that the solid electrolyte layers faced each other, and were subjected to hot roll pressing. A power generation element including the positive electrode, the solid electrolyte layer, and the negative electrode in this order was produced thereby. A container made of an aluminum laminate film was vacuum-sealed with the power generation element inside to produce a battery of Example 3-1.

### Example 3-2

LTO, a conductive additive (VGCF-H manufactured by SHOWA DENKO K.K.), tetralin, a LiI—LiBr—Li₂S—P₂S₅-based glass ceramic, a first dispersant, and a second dispersant were mixed to produce a first liquid mixture. 1-Hydroxyethyl-2-alkenylimidazoline (DISPERBYK-109 manufactured by BYK) was used as the first dispersant, and dimethylpalmitylamine was used as the second dispersant. The first liquid mixture was subjected to dispersion treatment using an ultrasonic homogenizer. A slurry according to Example 3-2 was produced in this manner.

The slurry according to Example 3-2 and a binder solution were mixed to produce a second liquid mixture. A solution containing SBR dissolved in tetralin was used as the binder solution. The second liquid mixture was subjected to dispersion treatment using an ultrasonic homogenizer. A negative electrode composition according to Example 3-2 was produced in this manner.

A battery according to Example 3-2 was obtained in the same manner as in Example 3-1, except that the negative electrode composition according to Example 3-2 was used.

### Example 3-3

A battery according to Example 3-3 was obtained in the same manner as in Example 3-1, except that 4-dodecylphenol was used as the first dispersant and oleyl alcohol was used as the second dispersant.

### Comparative Example 3-1

A battery according to Comparative Example 3-1 was obtained in the same manner as in Example 3-1, except that, in the production of the negative electrode composition, the second dispersant was not added and the amount of the first dispersant was increased by the same amount as the second dispersant in Example 3-1.

### Comparative Example 3-2

A battery according to Comparative Example 3-2 was obtained in the same manner as in Example 3-1, except that, in the production of the negative electrode composition, the first dispersant was not added and the amount of the second dispersant was increased by the same amount as the first dispersant in Example 3-1.

### Comparative Example 3-3

A battery according to Comparative Example 3-3 was obtained in the same manner as in Comparative Example 3-1, except that oleic acid was used as the first dispersant.

### [Measurement of Arithmetic Surface Roughness]

The negative electrode composition was applied to an aluminum foil using an applicator with a 100 μm gap to form a coating film. The coating film was dried at 100° C. for 15 minutes to produce a negative electrode sheet. The arithmetic surface roughness Sa of a surface of the negative electrode sheet was measured. The measurement was performed in an argon glove box having a dew point of −60° C. or lower. The measurement of the arithmetic surface roughness Sa was performed using a shape measurement laser microscope VK—X1000 manufactured by Keyence Corporation. The surface of the negative electrode sheet was observed using a 50× objective to obtain an image. This image was analyzed to determine the arithmetic average roughness Sa of the surface of the negative electrode sheet. Table 3 shows the results.

### [Measurement of Ionic Conductivity]

An evaluation cell was produced using each of the negative electrode compositions produced in Examples and Comparative Examples. Specifically, the negative electrode composition was applied to an aluminum foil to form a coating film. This coating film was dried for 30 minutes on a hot plate heated at 100° C. A negative electrode including the negative electrode current collector and the negative electrode layer was obtained in this manner. Next, the thickness of the negative electrode layer was measured. After that, the negative electrode current collector was peeled off the negative electrode. A solid electrolyte layer and a lithium foil were disposed on different surfaces of the resulting negative electrode layer to produce a layered body. A piece was punched out of the layered body and was sealed in a laminate film. Evaluation cells according to Examples and evaluation cells (control cells) according to Comparative Examples were produced thereby. A current value was measured for each evaluation cell under a constant voltage from −0.1 V to +0.1 V, and a resistance was calculated according to Ohm's law. The ionic conductivity of the negative electrode layer was determined from the resistance and the thickness of the negative electrode layer. Table 3 shows the results. Note that the ionic conductivity shown in Table 3 is a relative value determined when the ionic conductivity of the negative electrode layer according to Comparative Example 3-1 is defined as 1.

### [Measurement of Resistance]

Discharge resistances of the batteries produced in Examples and Comparative Examples were measured. Specifically, constant current charging was performed for each battery at a current corresponding to 1 C until a cell voltage reached 2.7 V. Subsequently, constant voltage charging was performed for the battery until a charging current reached a current corresponding to 0.01 C. Moreover, constant current discharging was performed at a current corresponding to 1 C until the cell voltage reached 1.5 V. This charge and discharge cycle was repeated twice, and a discharge capacity at the second cycle was measured.

Next, constant current charging was performed at a current corresponding to 1 C to half the discharge capacity at the second cycle, and the SOC of the battery was adjusted to 50%. The term “SOC” is an abbreviation of “state of charge”. The SOC is a measure of the state of charge of a battery. Then, constant current charging was performed at a current corresponding to 48 C for the battery whose SOC was adjusted to 50%. A voltage before this charging and a voltage five seconds after the start of this charging were measured. A difference between these voltages was divided by a current value corresponding to 48 C to determine a charging resistance (DC resistance). Table 3 shows the results. Note that the charging resistance shown in Table 3 is a relative value determined when the charging resistance of the battery according to Comparative Example 3-1 is defined as 1.

In Table 3, “Dispersion procedure” shows the order in which the materials were mixed. “A” indicates that, as described in Example 3-1, the first liquid mixture including the electrode active material, the first dispersant, and the solvent was produced, the solid electrolyte, the second dispersant, and the binder solution were added to the first liquid mixture to produce the second liquid mixture, and then the second liquid mixture was subjected to dispersion treatment. “B” indicates that the electrode active material, the solid electrolyte, the first dispersant, the second dispersant, and the solvent were mixed at once.

TABLE 3

| | | | | | Ionic | |
|---|---|---|---|---|---|---|
| | | | | Arithmetic | conductivity | Charging |
| | | | | surface | of negative | resistance |
| | | | Dispersion | roughness | electrode layer | (Relative |
| | First dispersant | Second dispersant | procedure | Sa (μm) | (Relative value) | value) |
| Example 3-1 | 1-Hydroxyethyl-2- | Dimethylpalmitylamine | A | 0.233 | 1.16 | 0.985 |
| | alkenylimidazoline | | | | | |
| Example 3-2 | 1-Hydroxyethyl-2- | Dimethylpalmitylamine | B | 0.228 | 1.14 | 0.974 |
| | alkenylimidazoline | | | | | |
| Example 3-3 | 4-Dodecylphenol | Oleyl alcohol | A | 0.194 | 1.05 | 0.991 |
| Comparative | 1-Hydroxyethyl-2- | — | A | 0.232 | 1 | 1 |
| Example 3-1 | alkenylimidazoline | | | | | |
| Comparative | — | Dimethylpalmitylamine | A | 0.234 | 1.27 | 1.01 |
| Example 3-2 | | | | | | |
| Comparative | Oleic acid | — | A | 0.206 | 0.61 | 1.03 |
| Example 3-3 | | | | | | |

The ionic conductivities of the negative electrode layers of Examples 3-1 to 3-3 were greater than that of Comparative Example 3-1. The batteries of Examples 3-1 to 3-3 exhibited a charging resistance lower than that of the battery of Comparative Example 3-1. The results for Examples 3-1 to 3-3 reveal that the charging resistance of the battery is effectively decreased by including both the first dispersant suitable for dispersion of the electrode active material and the second dispersant suitable for dispersion of the solid electrolyte.

The arithmetic average roughnesses Sa of the surfaces of the negative electrode sheets of Examples 3-1 to 3-3 were favorable.

Table 3 does not show every combination of the first dispersants shown in Table 1 and the second dispersants shown in Table 2. However, comprehensive evaluation of the results shown in Table 1, Table 2, and Table 3 suggests that if other combinations, such as a combination of diethanol laurylamine as the first dispersant and isostearyl alcohol as the second dispersant, than those in Examples 3-1 to 3-3 are used, favorable results will be able to be obtained as in the case for Examples 3-1 to 3-3.

The ionic conductivity of the negative electrode layer of the battery of Comparative Example 3-2 was high, but the charging resistance of the battery of Comparative Example 3-2 was greater than that of the battery of Comparative Example 3-1. The reason why the charging resistance of Comparative Example 3-2 is high despite of the high ionic conductivity is thought to be due to a poor dispersibility of the electrode active material. This is suggested by the results shown in Table 1. As for Comparative Example 3-1 and Comparative Example 3-3, the dispersibility of the electrode active material is considered favorable. However, it is thought that since only the first dispersant unsuitable for dispersion of the solid electrolyte was used in each of Comparative Example 3-1 and Comparative Example 3-3, the surface of the solid electrolyte layer was deteriorated due to a high acidity of the slurry to form a resistive layer. This resulted in the decrease in ionic conductivity and the increase in charging resistance. This is suggested by the results shown in Table 2.

### INDUSTRIAL APPLICABILITY

The electrode composition of the present disclosure can be used, for example, for manufacturing all-solid-state lithium-ion secondary batteries.

What is claimed is:

1. An electrode composition comprising:
an electrode active material;
a solid electrolyte;
a solvent; and
a dispersant, wherein
the dispersant comprises a first dispersant and a second dispersant,
the first dispersant comprises at least one selected from the group consisting of phenols and an amino hydroxy compound, and
the second dispersant comprises at least one selected from the group consisting of a nitrogen-containing compound and an alcohol.

2. The electrode composition according to claim 1, wherein the nitrogen-containing compound is a compound classified neither as the phenols nor as the amino hydroxy compound.

3. The electrode composition according to claim 1, wherein the phenols comprise at least one selected from the group consisting of a chain alkyl group having 9 or more carbon atoms and a chain alkenyl group having 9 or more carbon atoms.

4. The electrode composition according to claim 1, wherein the amino hydroxy compound comprises at least one selected from the group consisting of a chain alkyl group having 8 or more carbon atoms and a chain alkenyl group having 8 or more carbon atoms.

5. The electrode composition according to claim 1, wherein the nitrogen-containing compound is represented by the following chemical formula (1): 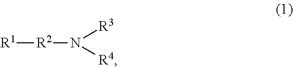
where
R¹ comprises a chain alkyl group having 7 or more and 21 or less carbon atoms or a chain alkenyl group having 7 or more and 21 or less carbon atoms,
R² is —CH₂—, —CO—, or —NH(CH₂)₃—, and
R³ and R⁴ are each independently a chain alkyl group having 1 or more and 22 or less carbon atoms, a chain alkenyl group having 1 or more and 22 or less carbon atoms, or a hydrogen atom.

6. The electrode composition according to claim 1, wherein the alcohol comprises at least one selected from the group consisting of a chain alkyl group having 10 or more carbon atoms and a chain alkenyl group having 10 or more carbon atoms.

7. The electrode composition according to claim 1, wherein the electrode active material comprises an oxide.

8. The electrode composition according to claim 1, wherein the solid electrolyte comprises a sulfide solid electrolyte.

9. The electrode composition according to claim 1, further comprising a binder.

10. The electrode composition according to claim 9, wherein the binder comprises at least one selected from the group consisting of a styrene-ethylene/butylene-styrene block copolymer and a styrene-butadiene rubber.

11. The electrode composition according to claim 5, wherein
in the chemical formula (1),
R¹ comprises at least one selected from the group consisting of a linear alkyl group having 7 or more and 21 or less carbon atoms and a linear alkenyl group having 7 or more and 21 or less carbon atoms,
R² is —CH₂—, and
R³ and R⁴ are each independently-CH₃ or —H.

12. The electrode composition according to claim 1, wherein the nitrogen-containing compound comprises at least one selected from the group consisting of dimethylpalmitylamine and oleylamine.

13. The electrode composition according to claim 1, wherein the amino hydroxy compound comprises 1-hydroxyethyl-2-alkenylimidazoline.

14. The electrode composition according to claim 1, wherein the second dispersant is a dispersant of a different type from the first dispersant.

15. A battery comprising:
a positive electrode;
a negative electrode; and
an electrolyte layer disposed between the positive electrode and the negative electrode, wherein
at least one selected from the group consisting of the positive electrode and the negative electrode comprises a dispersant,
the dispersant comprises a first dispersant and a second dispersant,
the first dispersant comprises at least one selected from the group consisting of phenols and an amino hydroxy compound, and
the second dispersant comprises at least one selected from the group consisting of a nitrogen-containing compound and an alcohol.
